(19) United States
(12) Patent Application Publication
(10) Pub. No.: US 2003/0236708 A1
(43) Pub. Date: Dec. 25, 2003

(54) Electronic program guides utilizing demographic stereotypes

(76) Inventor: David J. Marsh, Sammamish, WA (US)

Correspondence Address: LEE & HAYES PLLC, 421 W RIVERSIDE AVENUE SUITE 500, SPOKANE, WA, 99201

(21) Appl. No.: 10/175,970

(22) Filed: Jun. 19, 2002

(51) Int. Cl. G06F 17/60

(52) U.S. Cl. 705/26

(57) ABSTRACT

Various methods and systems make use of demographic stereotypes to provide powerful tools for enhancing the user's experience in the context of electronic program guides (EPGs). Stereotypes or stereotype groups can be used as a basis to configure aspects of an EPG system so as to do such things as make program recommendations to individual users. Further, stereotypes or stereotype groups can be used in various targeted advertising scenarios to enhance not only the user's experience and protect their privacy, but to facilitate the efficiency with which advertisers can target their intended consumers.

### RELATED APPLICATIONS

This application is related to the following U.S. patent applications, the disclosures of which are incorporated by reference herein:

application Ser. No. 10/125,260, filed Apr. 16, 2002, entitled “Media Content Descriptions” and naming Dave Marsh as inventor;

application Ser. No. 10/125,259, filed Apr. 16, 2002, entitled “Describing Media Content in Terms of Degrees” and naming Dave Marsh as inventor;

application Ser. No. ______, bearing Attorney Docket No. ms1-1088, filed May 11, 2002, entitled “Scoring And Recommending Media Content Based On User Preferences”, and naming Dave Marsh as inventor;

application Ser. No. ______, bearing Attorney Docket No. ms1-1175, filed May 31, 2002, entitled “Entering Programming Preferences While Browsing An Electronic Programming Guide”, and naming Dave Marsh as inventor; and

application Ser. No. ______, bearing Attorney Docket No. ms1-1186, filed Jun. 6, 2002, entitled “Methods and Systems for Generating Electronic Program Guides”, and naming Dave Marsh as inventor.

application Ser. No. ______, bearing Attorney Docket No. ms1-1204, filed , entitled “Methods and Systems for Enhancing Electronic Program Guides”, and naming Dave Marsh as inventor.

### TECHNICAL FIELD

This invention relates to media entertainment systems and, in particular, to systems and methods that are directed to personalizing a user's experience.

### BACKGROUND

Many media entertainment systems provide electronic programming guides (EPGs) that allow users to interactively select programs that they are interested in. Systems that employ EPG technology typically display programs organized according to the channel on which the program will be broadcast and the time at which the broadcast will occur. Information identifying a particular program typically includes the program title, and possibly a short description of the program. In today's world, media entertainment systems can typically offer hundreds of channels from which a user can choose. In the future, many more channels will undoubtedly be offered. This alone can present a daunting task for the user who wishes to locate particular programs of interest. Further complicating the user's experience is the fact that many current electronic programming guides (EPGs) can provide an abundance of information that can take several hours for a user to look through.

Against this backdrop, what many viewers typically end up doing is that they simply review a few favorite channels to see when their favorite programs are playing, and then view those programs at the appropriate times. Additionally, other viewers may simply revert to channel surfing. Needless to say, these outcomes do not provide the user with the best user experience or make effective and efficient use of the user's time.

Accordingly, this invention arose out of concerns associated with providing improved systems and methods that can provide media entertainment users with a rich, user-specific experience.

### SUMMARY

Various methods and systems make use of demographic stereotypes to provide powerful tools for enhancing the user's experience in the context of electronic program guides (EPG). Stereotypes or stereotype groups can be used as a basis to initially configure aspects of an EPG system. For example, a User Preference File that provides a means by which program recommendations are made to individual users can initially be seeded with data that represents the stereotype of a particular user. The user can then modify the User Preference File to tailor it to their specific preferences.

Stereotypes can also be employed in the context of collaborative filtering to provide dependency networks that can be utilized to make program recommendations to individual users within a particular stereotype.

Demographic stereotypes can also be used in various targeted advertising scenarios to enhance not only the user's experience and protect their privacy, but to facilitate the efficiency with which advertisers can target their intended consumers.

### BRIEF DESCRIPTION OF THE DRAWINGS

FIG. 1 is a block diagram that illustrates program data in accordance with one or more embodiments.

FIG. 2 is a block diagram that illustrates an exemplary environment in which methods, systems, and data structures in accordance with the described embodiments may be implemented.

FIG. 3 is a block diagram that illustrates exemplary components of a content folder in accordance with one embodiment.

FIG. 4 is a flow diagram describing steps in a method in accordance with one embodiment.

FIG. 5 is a high level block diagram that illustrates aspects of but one system that can be utilized to implement one or more embodiments.

FIG. 6 is a block diagram that illustrates exemplary components of a client device in accordance with one embodiment.

FIG. 7 is a block diagram that illustrates a recommendation engine in accordance with one embodiment.

FIG. 8 is a flow diagram describing steps in a method in accordance with one embodiment.

FIG. 9 is a flow diagram describing steps in a method in accordance with one embodiment.

FIG. 10 is a block diagram that illustrates various aspects of collaborative filtering techniques that can be utilized in accordance with one or more embodiments.

FIG. 11 is a flow diagram describing steps in a method in accordance with one embodiment.

FIG. 12 is a flow diagram describing steps in a method in accordance with one embodiment.

FIG. 13 is a block diagram that illustrates aspects of targeted advertising in accordance with one embodiment.

FIG. 14 is a flow diagram describing steps in a method in accordance with one embodiment.

FIG. 15 is a flow diagram describing steps in a method in accordance with one embodiment.

FIG. 16 is a block diagram that illustrates various components that can comprise a client device.

### DETAILED DESCRIPTION

Overview

Various methods and systems make use of demographic stereotypes to provide powerful tools for enhancing the user's experience in the context of electronic program guides (EPG). Stereotypes or stereotype groups can be used as a basis to initially configure aspects of an EPG system. For example, a User Preference File that provides a means by which program recommendations are made to individual users can initially be seeded with data that represents the stereotype of a particular user. The user can then modify the User Preference File to tailor it to their specific preferences.

Stereotypes can also be employed in the context of collaborative filtering to provide dependency networks that can be utilized to make program recommendations to individual users within a particular stereotype. Collaborative filtering can be used to define dependency networks for individual stereotype groups. The dependency networks can then be used, for individual users within a particular stereotype group, to make recommendations as to programs that might be of interest to the user.

Demographic stereotypes can also be used in various targeted advertising scenarios to enhance not only the user's experience and protect their privacy, but to facilitate the efficiency with which advertisers can target their intended consumers. For example, multiple channels can be provided for carrying commercials that pertain to particular stereotype groups. A client device can determine the stereotype group of its user(s) and then selected an appropriate commercial channel or channels so that it can subsequently present the commercials to the appropriate user. Alternately, a matching process can be employed to match up particular users in a stereotype group with tagged commercials that are targeted for that stereotype group. Other embodiments can use stereotype groups to automatically configured an EPG user interface.

The discussion below begins with a description of an exemplary system and approach that can be utilized to implement the embodiments that are described further on in this document. It is to be appreciated that the embodiments described herein can be implemented in connection with any suitable EPG system. Hence, the claimed subject matter should not be limited to only those systems that are the same as, or similar to those described below.

Content Description Metadata Collection

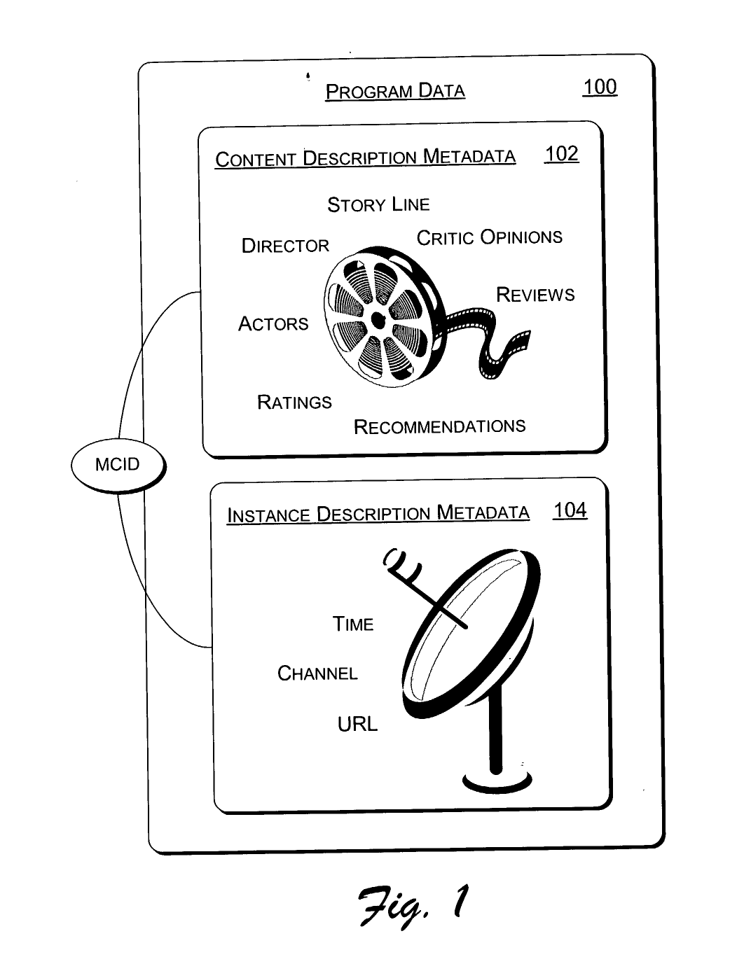

FIG. 1 illustrates two categories of program data 100 that can be associated with various media content (such as movies, television shows and the like) in accordance with the described embodiments. The two types of program data comprise content description metadata 102 and instance description metadata 104.

Content description metadata 102 can comprise a vast number of different types of metadata that pertain to the particular media content. The different types of content description metadata can include, without limitation, the director or producer of the content, actors in a program or movie, story line, ratings, critic opinions, reviews, recommendations, and the like.

Instance description metadata 104 comprises data that pertains to when and where the media content is available. For example, instance description metadata can include the day, time and television channel on which a particular movie or television program will be broadcast. Because content description metadata 102 is associated with the media content itself, and not when a particular instance of the media content is to be broadcast, the content description metadata can be maintained and updated throughout the life of a particular piece of media content.

In accordance with the described embodiments, the content description metadata and the instance description metadata are linked via a media content identifier number 106 or “MCID”. An MCID is a unique number that is assigned to the piece of media content to identify it. The MCID can provide a basis by which the particular media content can be easily and readily identified. Once identified, metadata associated with the media content can be easily updated and extended. MCIDs can also be used to generate electronic programming guides for the users and can provide the basis by which a user's likes and dislikes are measured against media content for purposes of recommending to the user those programs that the user would most like to view.

Exemplary Environment

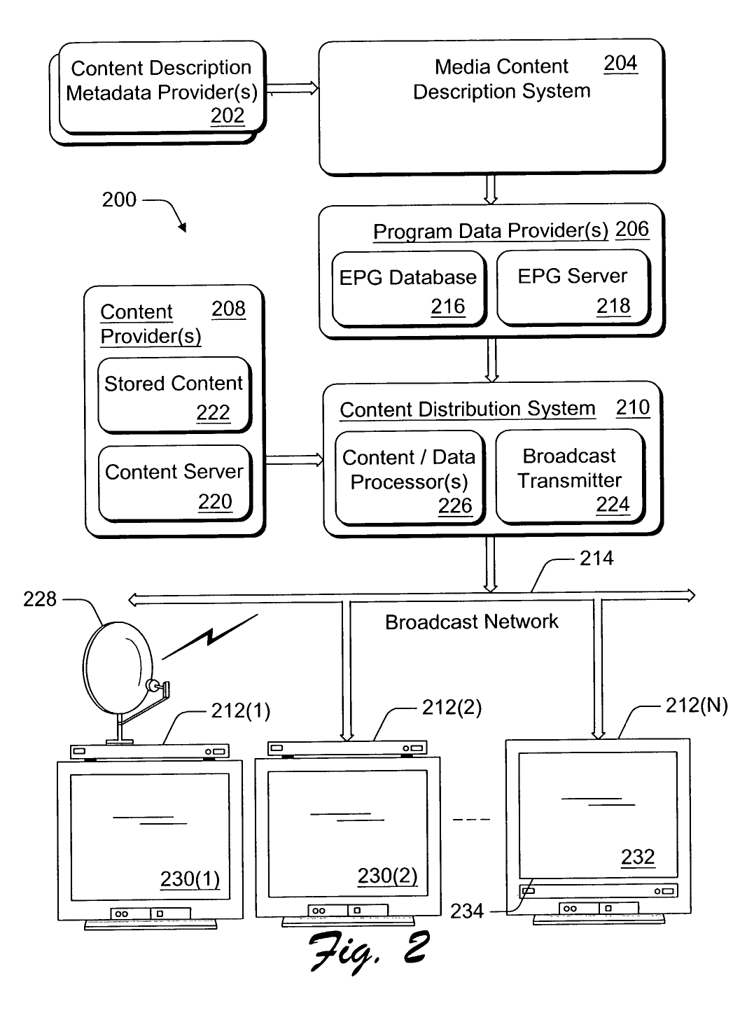

FIG. 2 illustrates an exemplary environment 200 in which the methods, systems, and data structures described herein may be implemented. The environment is a media entertainment system that facilitates distribution of media content and metadata associated with the media content to multiple users. Environment 200 includes one or more content description metadata providers 202, a media content description system 204, one or more program data providers 206, one or more content providers 208, a content distribution system 210, and multiple client devices 212(1), 212(2), . . . , 212(N) coupled to the content distribution system 210 via a broadcast network 214.

Content description metadata provider 202 provides content description metadata associated with media content to media content description system 204. Example content description metadata providers can include, without limitation, movie production companies, movie distribution companies, movie critics, television production companies, program distributors, music production companies, and the like. Essentially, any person, company, system, or entity that is able to generate or supply media content description metadata can be considered a content description metadata provider 202.

Media content description system 204 stores media content description metadata associated with a plurality of metadata categories and stores metadata received from one or more metadata providers 202. In one implementation, the media content description system 204 generates composite metadata based on metadata received from a plurality of metadata providers 202. Media content description system 204 provides the media content description metadata to program data provider 206. Typically, such metadata is associated with many different pieces of media content (e.g., movies or television programs).

Program data provider 206 can include an electronic program guide (EPG) database 216 and an EPG server 218. The EPG database 216 stores electronic files of program data which can be used to generate an electronic program guide (or, “program guide”). The program data stored by the EPG database, also termed “EPG data”, can include content description metadata 102 and instance description metadata 104. For example, the EPG database 216 can store program titles, ratings, characters, descriptions, actor names, station identifiers, channel identifiers, schedule information, and the like.

The EPG server 218 processes the EPG data prior to distribution to generate a published version of the EPG data which contains programming information for all channels for one or more days. The processing may involve any number of techniques to reduce, modify, or enhance the EPG data. Such processes can include selection of content, content compression, format modification, and the like. The EPG server 218 controls distribution of the published version of the EPG data from program data provider 206 to the content distribution system 210 using, for example, a file transfer protocol (FTP) over a TCP/IP network (e.g., Internet, UNIX, etc.). Any suitable protocols or techniques can be used to distribute the EPG data.

Content provider 208 includes a content server 220 and stored content 222, such as movies, television programs, commercials, music, and similar media content. Content server 220 controls distribution of the stored content 222 from content provider 208 to the content distribution system 210. Additionally, content server 220 controls distribution of live media content (e.g., content that is not previously stored, such as live feeds) and/or media content stored at other locations.

Content distribution system 210 contains a broadcast transmitter 224 and one or more content and program data processors 226. Broadcast transmitter 224 broadcasts signals, such as cable television signals, across broadcast network 214. Broadcast network 214 can include a cable television network, RF, microwave, satellite, and/or data network, such as the Internet, and may also include wired or wireless media using any broadcast format or broadcast protocol. Additionally, broadcast network 214 can be any type of network, using any type of network topology and any network communication protocol, and can be represented or otherwise implemented as a combination of two or more networks.

Content and program data processor 226 processes the media content and EPG data received from content provider 208 and program data provider 206 prior to transmitting the media content and EPG data across broadcast network 214. A particular content processor may encode, or otherwise process, the received content into a format that is understood by the multiple client devices 212(1), 212(2), . . . , 212(N) coupled to broadcast network 214. Although FIG. 2 shows a single program data provider 206, a single content provider 208, and a single content distribution system 210, environment 200 can include any number of program data providers and content providers coupled to any number of content distribution systems.

Content distribution system 210 is representative of a head end service that provides EPG data, as well as media content, to multiple subscribers. Each content distribution system 210 may receive a slightly different version of the EPG data that takes into account different programming preferences and lineups. The EPG server 218 creates different versions of EPG data (e.g., different versions of a program guide) that include those channels of relevance to respective head end services. Content distribution system 210 transmits the EPG data to the multiple client devices 212(1), 212(2), . . . , 212(N). In one implementation, for example, distribution system 210 utilizes a carousel file system to repeatedly broadcast the EPG data over an out-of-band channel to the client devices 212.

Client devices 212 can be implemented in multiple ways. For example, client device 212(1) receives broadcast content from a satellite-based transmitter via a satellite dish 228. Client device 212(1) is also referred to as a set-top box or a satellite receiving device. Client device 212(1) is coupled to a television 230(1) for presenting the content received by the client device, such as audio data and video data, as well as a graphical user interface. A particular client device 212 can be coupled to any number of televisions 230 and/or similar devices that can be implemented to display or otherwise render content. Similarly, any number of client devices 212 can be coupled to a television 230.

Client device 212(2) is also coupled to receive broadcast content from broadcast network 214 and communicate the received content to associated television 230(2). Client device 212(N) is an example of a combination television 232 and integrated set-top box 234. In this example, the various components and functionality of the set-top box are incorporated into the television, rather than using two separate devices. The set-top box incorporated into the television may receive broadcast signals via a satellite dish (similar to satellite dish 228) and/or via broadcast network 214. A personal computer may also be a client device 212 capable of receiving and rendering EPG data and/or media content. In alternate implementations, client devices 212 may receive broadcast signals via the Internet or any other broadcast medium.

Each client 212 runs an electronic program guide (EPG) application that utilizes the EPG data. An EPG application enables a TV viewer to navigate through an onscreen program guide and locate television shows of interest to the viewer. With an EPG application, the TV viewer can look at schedules of current and future programming, set reminders for upcoming programs, and/or enter instructions to record one or more television shows.

Content Folders

In accordance with the embodiments described below, the notion of a content folder is employed and utilized to hold metadata that pertains to media content that can be experienced by a user. The content folder can be utilized to hold or otherwise aggregate many different types of metadata that can be associated with the media content—including the media content itself The metadata that is provided into a content folder can come from many different metadata providers and can be provided at any time during the life of the media content.

As an example, consider the following. When media content is first created, content description metadata can be provided for the particular media content. Such content description metadata can include such things as the name of the content (such as movie or program name), actors appearing in the movie or program, year of creation, director or producer name, story line description, content rating and the like.

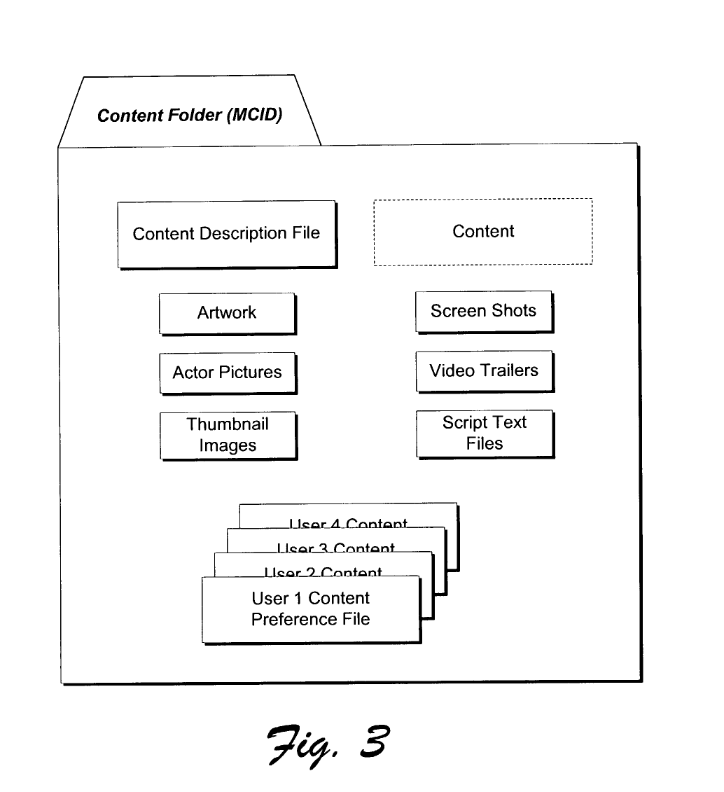

As an example, consider FIG. 3 which shows an exemplary content folder. The content folder is associated with a particular piece of content and, hence, is associated with an MCID that identifies the content. Within the content folder, many different types of metadata can be collected. For example, the content folder can include, without limitation, a content description file that describes the content (an example of which is provided below), and files associated with any artwork that might be associated with the content, actor pictures, thumbnail images, screen shots, video trailers, and script text files, to name just a few. The content folder can also contain the actual content itself, such as a digitally encoded program or movie. The content folder can, in some embodiments, contain one or more user content preference files which are described in more detail in the section entitled “User Content Preference File” below.

Over time, more content description metadata may become available and can be added to the content folder. For example, after a movie is released, critic opinions and recommendations may become available. Because this is information related to the media content itself (and not just a particular broadcast or showing of the media content), this information can be added to the content folder. At a still later point in time, additional reviews of the media content may become available and can thus be added to the content folder. Additional metadata that can be incorporated into the content folder can include such things as special promotional data associated with the content, data from fan sites, and many more different types of metadata.

Content description metadata can typically be generated by many different sources (e.g., movie production companies, movie critics, television production companies, individual viewers, etc.). A media content description system (such as system 204 in FIG. 2) can store content description metadata from the multiple sources, and can make the content description metadata available to users via one or more servers or other content distribution systems.

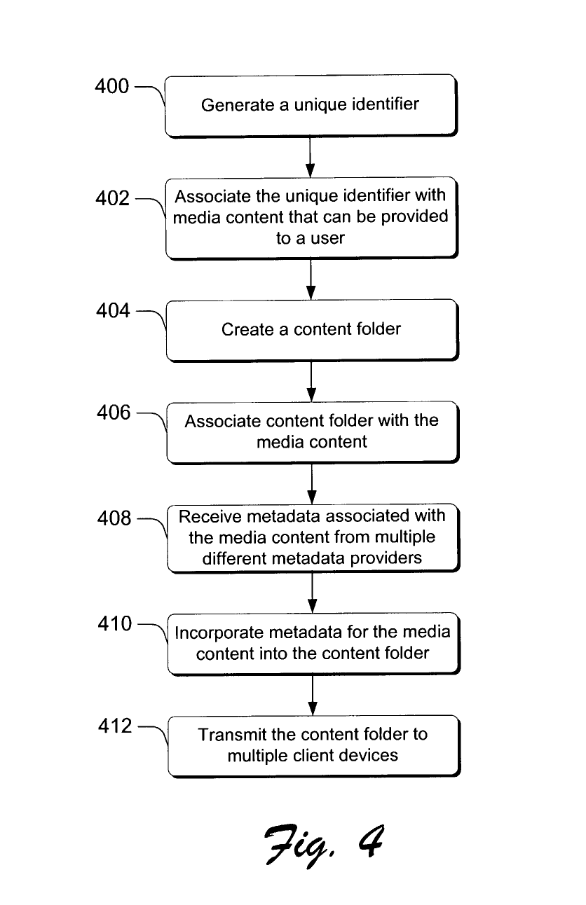

FIG. 4 is a flow diagram that describes steps in a metadata collection method in accordance with one embodiment. The steps can be implemented in any suitable hardware, software, firmware or combination thereof. In the illustrated example, the steps can be implemented in connection with a metadata collection and transmission system. Exemplary components that can perform the functions about to be described are shown and described in connection with FIG. 2.

Step 400 generates a unique identifier and step 402 associates the unique identifier with media content that can be provided to a user. An example of such a unique identifier is described above in connection with the MCID. The media content with which the unique identifier can be associated is a specific piece of media content, such as a specific movie or television program. In practice, these steps are implemented by one or more servers or other entities in connection with a vast amount of media content. The servers or entities serve as a collection point for metadata that is to be associated with the particular media content. Step 404 creates a content folder and step 406 associates the content folder with the particular media content. These steps can also be performed by the server(s) or entities. The intent of these steps is to establish a content folder for each particular piece of media content of interest.

Step 408 receives metadata associated with the media content from multiple different metadata providers. These metadata providers need not and typically are not associated or affiliated with one another. Step 410 then incorporates the metadata that is received from the various metadata providers into the content folder that is associated with the particular media content. As noted above, this process is an ongoing process that can extend during the entire life of the particular piece of media content. The result of this step is that, over time, a very rich and robust collection of metadata is built up for each piece of media content of interest. Software executing on the server can use aggregation techniques to ascertain the best value for each program attribute using the entries from the different metadata providers. For example, different opinions as to the value of attributes can be collected from the different metadata providers. The “best” value, i.e. the one that gets sent to the client, is built by the server software using various techniques depending on the attribute type. For example, sometimes the best value is the value from the most trustworthy metadata provider. Yet other times, a vote can be taken as to the best value. Still further, for example in the case of “Degrees Of” attributes, percentages can be calculated by looking at all of the opinions from the metadata providers. Data aggregation techniques are described in some of the applications incorporated by reference above. An example of a content folder is shown and described in FIG. 3.

Step 412 transmits the content folder to multiple different client devices. This step can be implemented by transmitting all of the constituent files of the content folder, or by transmitting a pared down version of the content folder—depending on the needs and capabilities of the particular client devices to which transmission occurs.

The content folders can be used in different ways. For example, the content folder can be used in an EPG scenario to enable the EPG software on the client device to generate and render an EPG for the user. The content folder can also be used by end users to hold not only the metadata for the media content, but the media content as well.

Using Content Folders to Generate EPGs

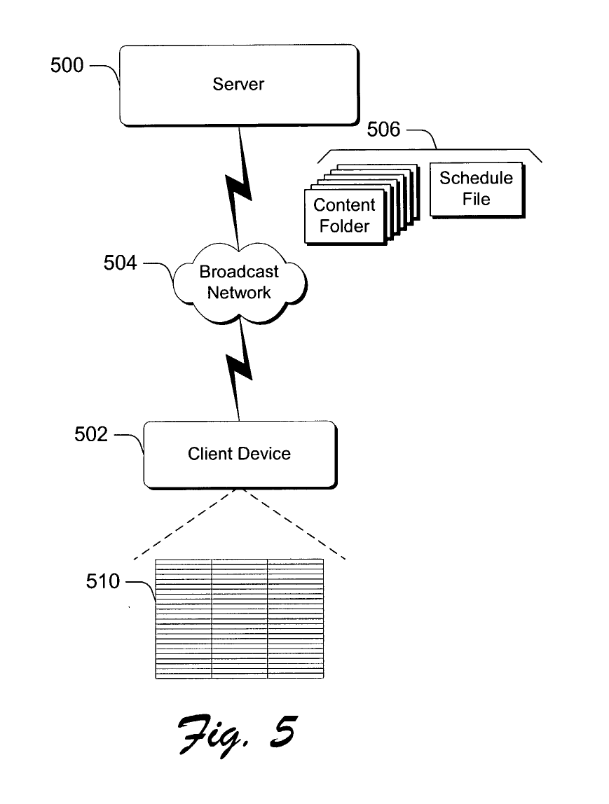

FIG. 5 is a block diagram that can be used to understand bow the client device can use the various content folders to generate an EPG. In this example, a server 500 builds and maintains many different content folders, such as the content folders that are described above. In addition, the server can build a schedule file. The content folders and schedule files are shown collectively at 506.

The schedule file is a description of the programs that are to be broadcast over a future time period for which an EPG is going to be constructed. For example, the schedule file can describe which programs are going to be broadcast for the next two weeks. Thus, the schedule file contains the instance description metadata as described in FIG. 1. The schedule file can be implemented as any suitable type of file. In this particular example, the schedule file is implemented as an XML file. The schedule file refers to the pieces of media content (i.e. programs) by way of their respective unique identifiers or MCIDs. Thus, the schedule file contains a list of MCIDs, the times when, and the channels on which the associated programs are going to be broadcast.

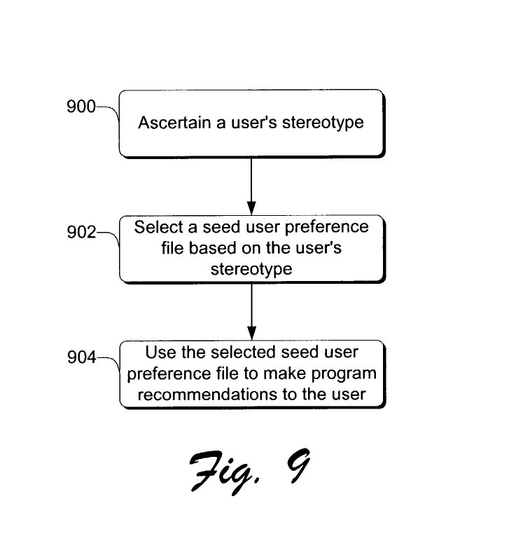

The schedule file and content folders that correspond to the MCIDs in the schedule file are transmitted, via a suitable broadcast network 504, to multiple client devices such as client device 502. The client device can now use the schedule file and the various content folders to construct an EPG grid, such as EPG 510, for the user. A specific example of an EPG such as one that can be generated in accordance with the embodiments described herein is shown in FIG. 9.

Specifically, when the client device receives the schedule file, an EPG application executing on the client device can read the schedule file and ascertain the MCIDs that correspond to the programs that are going to be broadcast. The EPG application can then construct a suitable grid having individual cells that are to contain representations of the programs that are going to be broadcast. Each cell typically corresponds to a different MCID. To populate the grid, the EPG application can access the appropriate the content folders, by virtue of the MCIDs that are associated with the content folders, and render the metadata contained in the content folder in the appropriate cell for the MCID of interest. The EPG application can also provide any user interface (UI) components that are desirable to access additional metadata that is not necessarily displayed—such as a movie trailer, a hyperlink and the like.

In one embodiment, an optimization can be employed to ensure that client devices are provided metadata within the content folder that they can use. Thus, metadata that is not necessarily useful for the client device can be excluded from the content folder that is transmitted to the client device. For example, if the client device does not have a position in its user interface to display a particular piece of information, or if the client device lacks the necessary resources to meaningfully use the metadata (e.g. the client lacks the capabilities to display a video trailer), then such metadata should not be transmitted to the client device when the content folders are transmitted. One way of implementing such an optimization is as follows. Prior to downloading the content folders, server 500 and client device 502 communicate with one another by, for example, a SOAP protocol, and the client device identifies for the server which information or metadata it is interested in. This can assist the server in assigning a class designation to the client device (e.g. thick client, thin client and/or varying degrees therebetween) so that the appropriate metadata is sent to the client.

The content folders can be used by the client device in a couple of different ways depending on the configuration and capabilities of the client device. For clients that are “thick” and support a database querying engine (such as a SQL engine), complex querying can be utilized locally on the client. In this case, certain files (such as the content description file) within the content folder can be read into the client's database and requests for program information can be sent from the EPG application to the database engine for execution. Support files such as the artwork and trailer files are not loaded into the database, but rather are read by the EPG application directly from the content folders. For clients that do not support a database engine, metadata can be read directly from the files.

Using Content Folders to Organize Metadata and Media Content

Content folders can also be used to contain not only the pertinent metadata, but the associated media content as well. This use can occur on either the server or the client side. Typically, however, this use will occur with more frequency on the client side.

Recall from FIG. 5 and the discussion above, that the client devices typically receive multiple different content folders that are individually associated with specific media content that has yet to be broadcast. Thus, as noted in FIG. 3, the client devices will typically have a number of these content folder without the associated content. When the content is acquired by the client, as by being broadcast or downloaded (for example in a Personal Video recorder application), the content itself can be added to the content folder so that individual content folders now contain not only pertinent metadata, but the corresponding content as well. Typically, such content can be digitally encoded into an appropriate file (such as an MPEG 2 file) and added to the content folder.

This can be advantageous from the standpoint of being able to abstract a specific piece of media content into an entity (i.e. the content folder) that represents not only the content itself, but a potentially rich user experience made possible by the inclusion of the various types of metadata with the content. Having an abstracted entity that contains not only the content, but the associated metadata as well can be employed in the context of peer-to-peer exchanges. For example, if a user wishes to provide a piece of content to a friend, then they can simply send them the abstracted entity that includes not only the content, but all of the supporting metadata files as well.

Exemplary Client Architecture

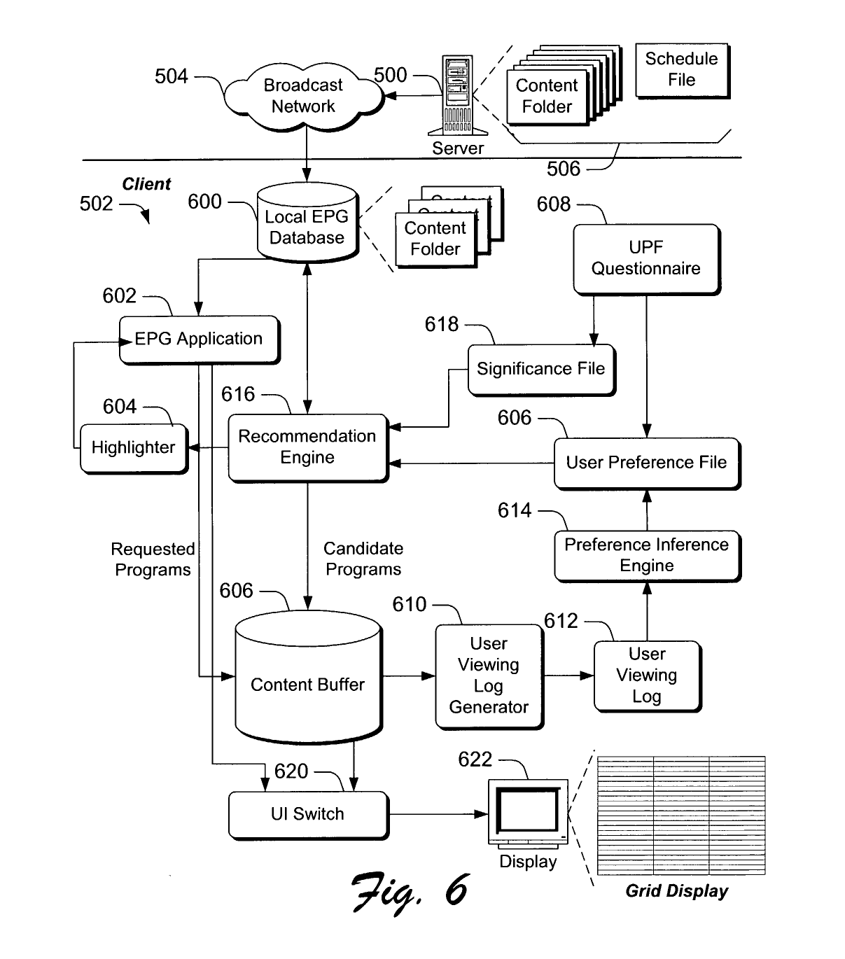

FIG. 6 is a block diagram that illustrates exemplary components of a client system or device 502 in accordance with one embodiment, and expands upon the client device shown and described in FIG. 5. Client system 502 can operate as a user preference recommendation system that can score programs that are available for viewing according to a user's preferences, and recommend certain programs that meet particular conditions that are specific to a particular user.

Client system 502 can include a local electronic programming guide (EPG) database 600 that stores content folders that can include content files, support files and content description files associated with the content files that are downloaded 11 from a server. An exemplary content description file is described in the section entitled “Content Description File” below. Database 600 can also store the schedule file. The database can comprise a traditional database such as that which would reside on a thick client. Alternately, for thin clients, the database would typically be less extensive than for thick clients.

The EPG database 600 provides data to an electronic programming guide (EPG) application 602. The EPG application 602 is configured to enable displays of program names, dates, times, lengths, etc. in a grid-like user interface. A highlighter component 604 can highlight particular programs displayed on an EPG grid. The particular programs that can be highlighted by the highlighter component 604 can be a function of a user's likes and dislikes. Client 502 also includes a content buffer 606 that can store content folders and media content associated with particular content folders. For example, the content buffer can be utilized to store programs that are designated by the user for recording so that the user can later view the program. This will become more apparent in connection with the discussion that appears in the section entitled “Recommendation Lists” below.

The client 502 also includes one or more user preference files (UPF) 606 associated with a user or users of the client. The client 502 can contain more than one user preference file for each user.

The user preference file can be utilized to store values for various attributes of media content (such as television programs). Each attribute value can have a preference value associated with it that indicates how much the particular user likes or dislikes that particular attribute value in a program. Advantageously, the user preference file and the content description file can conform to a common content description schema which can facilitate matching up various programs with the user's preferences. The user preference file 606 can advantageously allow for the separation of the process of establishing user preferences, from the process of matching the user preferences with programs that are available for viewing.

Various techniques can be utilized to populate user preference file 606 with useful information about the user, such as what attribute values of television programs are liked and disliked by the user.

One way to generate a user preference file is to provide the user with a UPF questionnaire 608 that queries the user directly about which attribute values are important to the user. After the user preference file is initially constructed, it can be periodically updated with new information about preferred program attribute values. The user may, for example, simply recall the UPF questionnaire 608 and add additional information or edit information that is already in the file.

Another way to generate a user preference file makes use of a user viewing log generator 610 that monitors programs that are watched by the user or listed by the user for consumption. Program attribute values associated with the monitored programs, together with the time that the program was viewed are logged in a user viewing log 612. At predetermined intervals, a preference inference engine 614 can build up the user preference file using information contained in the user viewing log 612. User preference files are described in more detail in the section entitled “User Preference File” below.

Client 502 also includes a recommendation or matching engine 616 that drives the comparison of a particular user preference file with content description files associated with programs that are available for viewing.

When recommendation engine 616 determines that an attribute value in the user preference file matches an attribute value found in a content description file, the matching engine 616 can calculate an attribute score for the matching attribute. For example, an “actor” attribute in the user preference file may contain a value of “Steve Martin.” If an “actor” attribute in the content description file also contains the value of “Steve Martin,” then the “actor” attribute is designated as a matching attribute. An attribute score can then be assigned to the matching attribute, and one or more attribute scores assigned in a program can be used to calculate a program score for the program.

In one embodiment, recommendation engine 616 can make use of a significance file 618 when calculating the scores of a particular program. The significance file can contain significance values that are utilized in the calculation of program scores. Significance files are described in more detail below in the section entitled “Significance Files”.

The output of recommendation engine 616 are various score-based recommendations that can be provided on a user-by-user basis. Various nuances of scoring characteristics and techniques are described below in more detail.

Client 502 can also comprise a user interface (UI) switch 620 and a display 622 such as a television or monitor on which an EPG grid can be rendered. Although the display is shown as being a part of client 502, it is to be appreciated and understood that the display can be separate from the client, such as in the case where the client is embodied in a set top box (STB). The UI switch 620 is effectively used to switch between stored programs in the content buffer 606 and live programs emanating from a content source.

Content Description Schema

As noted above, to facilitate matching attribute values that the user likes (as indicated in their user preference file) with the attribute values of the content programs (as indicated in the content description files) a comprehensive and consistent description schema is used to describe the content.

But one example of an exemplary content description schema that includes metadata categories that correspond to content attributes is described in U.S. patent application Ser. No. 10/125,260, incorporated by reference above.

User Preference File

The user preference file (UPF) is a global file that describes program attributes that the user likes. There is typically one user preference file per user, although users can have more than one user preference file for such things as representing multiple different user personas. In addition to describing the user's likes and dislikes in terms of program attributes, the user preference file can contain other global system attributes that relate to a particular user such as, for example, user interface setup options and programs the user always wishes to have recorded.

Against each program attribute is a preference number that can have a positive value (to indicate a level of desirability associated with content having that attribute), or a negative value (to indicate a level of undesirability associated with content having that attribute). In the example described below, preference numbers can range from −5 to +5.

The user preference file can be implemented in any suitable file format. In the example described below, the user preference file is implemented as an XML file and uses the same schema as the content description files (described in the section entitled “Content Description Files” below) that are used to describe the attributes of the content.

A representation of an exemplary content description schema as employed in the context of a user preference file appears directly below. This representation contains only an abbreviated selection of attributes and attribute values. Accordingly, a typical user preference file can contain more entries than those shown, and/or different attributes and/or attribute values.

<Person Entries>

<PersonName=“Julia Roberts” PersonRole=“Actor” Xpref=“−3”/>
<PersonChar=“Miss Marple” Xpref=“+1”/>
<PersonName=“Ron Howard” PersonRole=“Director” Xpref=“+5”/>

...
<Person Entries>
<Title Entries>

<TitleName=“Friday 13” Xpref=“+3”/>
<TitleName=“The Jerk” Xpref=“+5”/>

...
<Title Entries>

### EXAMPLE USER PREFERENCE FILE SCHEMA

The user preference file is defined in terms of the same metadata attributes or categories that are used to describe the content in the content description files. The user preference file, however, adds one or more additional attributes that are specific to its associated user. A separate but compatible schema could be used for both the user preference file and the content description file. However, as a content description schema is an evolving concept that can add additional metadata categories over time, it is more desirable, for purposes of synchronization, to have the schemas remain synchronized. Thus, it is desirable to use the same schema for both the content description file and the user preference file.

The excerpt of the user preference file above includes tags that encapsulate various attributes and their associated values. In this specific example, “Person Entries” tags encapsulate attributes and values associated with particular individuals or characters. “Title Entries” tags encapsulates attributes and values associated with particular titles.

The “Person Entries” tag encapsulates a “Person Name” attribute that is used to identify a person such as an actor who is preferred by a particular user. A Person Name attribute value contains a character string such as an actor's name, e.g. “Julia Roberts.” This indicates that the user corresponding to the particular user preference file has a preference—either a like or a dislike—for Julia Roberts in a particular context.

The “Person Entries” tag also encapsulates a “Person Role” attribute that identifies a particular function or context of the person identified in the “Person Name” attribute. This can allow a user to distinguish between actors who may also be directors in some programs. For example, the user may like movies in which Clint Eastwood stars, but may dislike movies in which Clint Eastwood directs. In this particular example, the “Person Role” attribute for Julia Roberts indicates that this entry pertains to Julia Roberts in the context of an actor, and not in some other context.

A preference attribute “Xpref=” is also provided for the “Person Name” and “Person Role” attributes and enables the user to enter a value or preference rating that indicates how much, relatively, the user likes or dislikes the value specified in the “Person Name” attribute for the context defined by the “Person Role” attribute. In this particular example, the user has indicated a value of “−3” for Julia Roberts in the context of an actor.

The “Person Entries” tag also encapsulates a “Person Character” attribute and value, as well as a preference attribute and rating associated with that “Person Character” attribute. The “Person Character” attribute enables a user to identify particular characters that the user likes or dislikes. In the present example, the Person Character attribute value comprises “Miss Marple”, and the preference rating associated with that character is “+1”. This indicates that the user slightly prefers programs in which this character appears.

There can be virtually any number of similar entries encapsulated by the “Person Entries” tag. For example, another “Person Name” attribute is defined for Ron Howard in the context of director and contains a preference rating of “+5”, which indicates a strong preference for programs directed by Ron Howard.

Similarly, the “Title Entries” tags encapsulate “Title Name” attributes and associated values, as well as associated preference attributes and their associated ratings. In this example, a first “Title Name” attribute equals “Friday 13” having an associated preference attribute with a rating of “+2”. A second “Title Name” attribute equals “The Jerk” having an associated preference attribute with a rating of“+5”.

Whether attribute values actually match or not, and the extent to which attribute values match with attributes in the content description files depends on the particular entry type. For example, entry types can be used when exact matches are desired. This might be the case where a user has a particular preference for movie sound tracks in the French language. Yet other entry types can be used when an exact match is not necessarily needed or desired. Such might be the case, for example, when a user is interested in any of the movies in the “Friday the 13^{th}”, series of movies. In this case, a match can be deemed to have occurred if the term “Friday 13” appears anywhere in the title of a movie.

Content Description File

Recall that each content folder, such as the one shown and described in FIG. 3, contains a content description file. In the present embodiment, the content description file uses the same schema as does the user preference file. The content of the files, however, can be different. An exemplary portion of a content description file is provided below. The content description file can contain more entries or attributes than those shown below. For example, attributes can include a title attribute, a content identifier attribute, a date of release attribute, a running time attribute, a language attribute, and the like.

<Person Entries>

<PersonName=“Russell Crowe” PersonRole=“Actor”/>
<PersonChar=“John Nash”/>

<Person Entries>
<Title Entries>

<TitleName=“A Beautiful Mind”/>

<Title Entries>

EXAMPLE CONTENT DESCRIPTION FILE SCHEMA

Accordingly, the “Person Entries” tag includes a “Person Name” attribute and value that are used to identify individuals associated with the content. In this particular case, the attribute can be used to designate actors appearing in a particular program. The “Person Entries” tag also includes a “Person Role” attribute and value that identifies a particular function or context of the person identified in the “Person Name” attribute. In this particular example, the “Person Name” and “Person Role” attributes for the content indicates that Russell Crowe is associated with the program in the context of an actor.

The “Person Entries” tag also encapsulates a “Person Character” attribute and value. The “Person Character” attribute identifies particular characters that appear in the program or movie. In the present example, the Person Character attribute value comprises “John Nash”.

Similarly, the “Title Entries” tags encapsulate a “Title Name” attribute and associated value which designates the title of the content. In this example, the “Title Name” attribute equals “A Beautiful Mind”.

As noted above, the user preference file and the content description file contain many of the same attributes. This is due to the fact that the files utilize the same content description schema to describe content attributes. This greatly facilitates the process of matching program attributes with a user's preferred attributes.

User Content Preference File

Various embodiments can also make use of user content preference files. A user content preference file is different from a user preference file. Recall that a user preference file is a global file that describes attributes that a user likes and dislikes. A user content preference file, on the other hand, is not a global file. Rather, the user content preference file is associated with each particular piece of content for each user or user preference file. The user content preference files are maintained in the content folder and describe how well a particular piece of content matches up with an associated user preference file. So, for example, if there are four users who use the particular client device, then there should be four User Preference Files that describe each user's likes and dislikes. For each content folder in the client system, then, there should be four User Content Preference files-one for each user describing how well this particular content matches up with the user's likes and dislikes.

User Content Preference files can facilitate the processing that is undertaken by the recommendation engine. Specifically, because of the large number of content folders, user preference files and the like, a recommendation engine can take a long time to execute. In practice, the recommendation engine is executed as a batch process. The results of the recommendation engine can be stored in the user content preference file so that they can be accessed by whatever application may need them.

In addition to indicating how well the particular content matches up with a user's user preference file, the user content preference file can include additional user-specific data that is particular to that piece of content. For example, if the user is a film buff and always wants to ensure that these particular movies are shown in a particular aspect ratio or using Dolby surround sound, such information can be located in the User Content Preference file.

The User Content Preference files can be used to generate human-readable reports that describe how the recommendation engine arrived at a particular score. This can be a desirable feature for more sophisticated users that can assist them in adjusting, for example, their program attribute preferences to refine the recommendations produced by the recommendation engine.

Significance File

Some program attribute matches that are found by the recommendation engine can be more important or significant than others. Significance values, as embodied in a significance file such as significance file 618 in FIG. 6, provide a way for the system to appropriately weight those things that are truly significant to a particular user.

A significance file is a global file that is used to store significance values that correspond to each attribute available in a program. Each significance value denotes a relative importance of the attribute with which it corresponds as compared to the other attributes. Use of significance values provides an appropriate weighting factor when determining whether a program should be recommended to a user or not. That is, when a recommendation engine compares a user's preference file with a content description file and finds a match between particular attribute values, the recommendation engine can multiply the preference rating for the matching attribute in the user's preference file with the corresponding significance value for that attribute in the significance. The product of this operation can then contribute to the overall score of a particular program for purposes of determining whether a recommendation should be made or not.

In accordance with one embodiment, the significance file uses the same schema as the content description file (so that everything stays in synch), and extends the schema by including an additional attribute (“XSignif”) that enables the user to express the significance of a particular attribute of the content description file. As an example, consider the excerpted portion of a significance file that appears directly below.

<Person Entries>

<PersonName=“ ” XSignif=“63”/>
<PersonChar=“ ” XSignif=“87”/>

<Person Entries>
<Title Entries>

<TitleName=“ ” XSignif=“99”/>

<Title Entries>

### EXAMPLE SIGNIFICANCE FILE SCHEMA

The above significance file excerpt includes a “Person Entries” tag and a “Title Entries” tag. These tags encapsulate many of the same attributes that appear in the user preference file and content description file.

Specifically a “Person Name” attribute is encapsulated by the “Person Entries” tag. Associated with the “Person Name” attribute is a significance attribute “XSignif” that is used to define the relative importance of a person associated with a particular piece of content as compared with other attributes. In this example, a significance value of “63” is assigned to the “Person Name” attribute. Assuming for purposes of this example that significance values range from zero to one hundred, a value of “63” indicates that a match of this attribute is generally important to the user.

A “Person Character” attribute is also encapsulated by the “Person Entries” tag, and the corresponding significance attribute “XSignif” of “87” indicates that a match of this attribute is more important to the calculation of the program score than a match of the “Person Name” attribute.

A “Title Name” attribute is encapsulated by the “Title Entries” tag and, in this example, an associated significance attribute “XSignif” of “99” indicates that a match of this attribute is even more important than a match of the “Person Character” attribute.

It should be noted that the significance values could be stored in the user preference files along with each entry therein, thereby making the significance values user specific rather than system wide. They could even be associated with the particular preferences, however, doing so would require redundant entries since some attributes may be repeated with different attribute values. For example, a user preference file may include fifty actors' names that a user prefers to see. If the significance values were to be included in the user preference file associated with particular preferences, then each of the fifty entries for actors' names would have to include the same significance value. Thus, by virtue of the fact that the significance file is a global file, such redundancies can be avoided.

Additionally, it should be appreciated that it is not necessary for the user to create and/or have control over the significance file. Rather, another entity such as a content provider may assign the significance values for a particular client system. While such an implementation would not provide as close a fit with each user's personal preferences, it would relieve the user from having to individually do the work.

As an example of how a client device or system can employ a significance file and significance values, consider the following. Assume that in a user's preference file the user includes the same rating or preference value (e.g. +5) for the “Title Name” and “Person Character” attributes. For example, perhaps the “Title Name” of concern is the “Seinfeld” show and the “Person Character” of interest is the Kramer character. Thus, in this instance, the user really likes the Seinfeld show and the Kramer character. Notice in the excerpted portion of the significance file that appears above, the “Title Name” attribute has a significance value of “99”, while the “Person Character” attribute has a significance value of “87”. Thus, although the user may enter the same preference value for the Title Name attribute value and the Person Character attribute value (i.e. +5) because the user strongly prefers both, all other things being equal, by using the significance file the system would determine that this user prefers a Seinfeld episode that features the Kramer character (with a corresponding score of 5*87+5*99=930) over a Seinfeld episode that does not feature the Kramer character (with a corresponding score of 5*99=495).

For many of the program attribute types, the significance file can have multiple numbers, each tagged with the type of match to which they relate. The most commonly used tags can be “Full” and “Part” which refer respectively to a full match or just a partial match. Finding a keyword within a plot abstract is an example of a partial match.

Running the Recommendation Engine

Typically, the recommendation engine is run or otherwise executed for every piece of content for every user on the client system. Needless to say, this can involve a fairly large amount of processing for the client system. Various strategies can be used on the client to effectively hide this processing time. This can be particularly important in the context of client devices that do not employ high end processors.

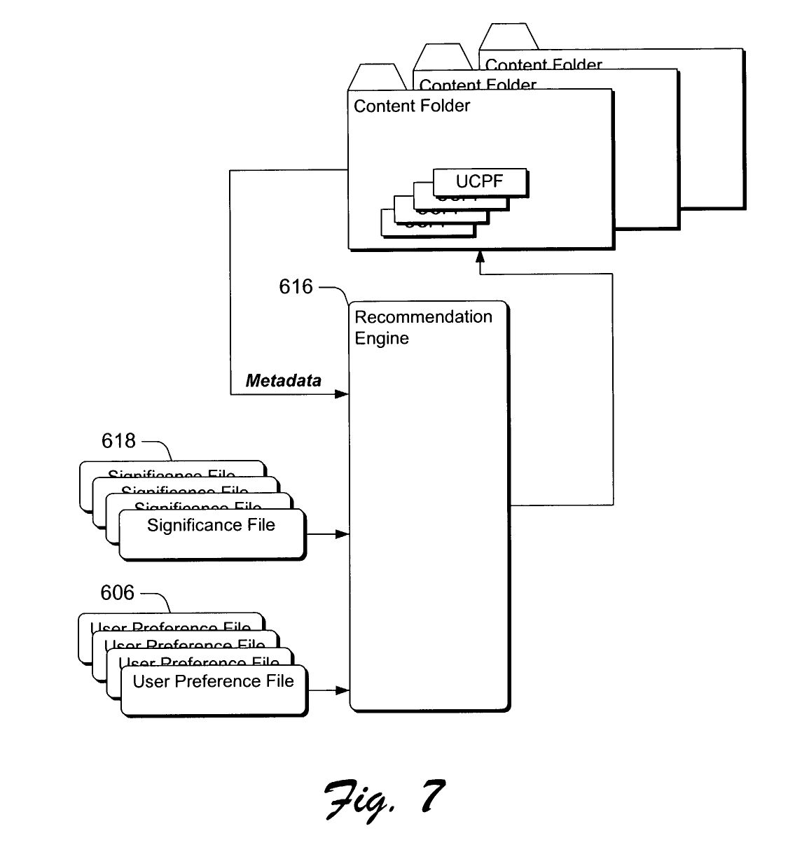

As an example, consider FIG. 7 which illustrates, in somewhat more detail, the processing that can take place at the recommendation engine 616. Typically, there are a number of different inputs to the recommendation engine. Here, the inputs can include the metadata from each of the content folders, the input from each user's associated significance file 618, and the input from each user's preference file 606. For each piece of content that the client receives (i.e. for each content folder), the recommendation engine is run with these inputs. The recommendation engine 616 processes inputs and then provides an output that includes, among other things, the scores for the various programs, for each user, that are slated for broadcasting during the next period of time. This data can be provided by the recommendation engine into user content preference files (UCP files) that are contained in each of the content folders. Additionally, the recommendation engine's output is also used to make recommendations for the various users via the EPG that is generated and displayed for the users. Those programs that more closely match a particular user's likes can be displayed more prominently than those program that do not closely match a user's likes.

In accordance with one embodiment, recommendation engine 616 can be run or executed as the content description information (i.e. the content folders) are downloaded from the server. Downloading of the content folders can be scheduled such that the content folders are downloaded at a time when the users are not likely to be using the client system, e.g. very early in the morning. Typically, content folders that are downloaded are associated with content that is to be broadcast up to a couple of weeks into the future. Downloads can be scheduled for once a day such that if for some reason a download does not happen on a particular day, the next day's download can catch up. In practice, it is usually sufficient for downloads to occur at least once a week so that the user's experience is not disrupted. Accordingly, scheduling downloads for every day can provide plenty of room to account for such things as bandwidth limitations and the like.

Thus, typically, the recommendation engine can be scheduled to run every night. In some situations, it can be desirable to immediately run the recommendation engine if, for example, something in the client system changes that would make running the recommendation engine desirable. For example, assume that a user is watching a particular program and something or someone in the program catches their eye. Perhaps they notice a new actor whom they really like. The user may opt to update their user preference file to reflect that they would like to have more recommendations made for any programs in which this particular actor appears. Here, then, it can be desirable to immediately run the recommendation engine to incorporate the user's new changes in their user preference file. This can provide the user with immediate feedback and recommendations. In practice, however, this may be unnecessary because the user's change may not necessarily change the overall scores very much.

Sorting the Scores

During the download of content description data (i.e. content folders), recommendation engine 616 calculates a score for each program. At the end of the complete process, the recommendation engine can sort the scores for all of the programs so that it is later able to display a sorted list of recommendations to the user. This list of sorted scores can be kept in a separate scores file. The scores file can include a list of the MCIDs for each of the programs and the corresponding score for each MCID. Each user can have a separate scores file that contains their own scores for the various programs. Using only an MCID is sufficient in this case because with the MCID, all other relevant information pertaining to a particular program can be accessed.

The scores file can be stored as part of the user preference file, or in an accompanying file that is associated with the user. The latter would go far to ensure that the user preference file does not become too bloated.

Privacy Issues

Because the user preference files and scores files contain sensitive information, various protections can be utilized to ensure that the user preference files and, if a separate file—the scores files—are protected.

To protect the user preference and scores files, the files can be encrypted and access to the files can be via password. Any suitable encryption techniques can be utilized such as DES or AES security techniques. Other methods of protection can be utilized such as storing the files on a removable smartcard.

Relative Scoring

As noted above, each program that is to be broadcast in a forthcoming schedule is given a score by the recommendation engine. The actual score that each program receives is not as important as the score's significance relative to all of the other scores. That is, it is more useful to assess the scores of each program relative to the scores for the other programs. Thus, it can be advantageous to translate each program's actual score into a relative score so that its importance to the individual users can be ascertained relative to the other programs that are to be broadcast.

In accordance with one embodiment, the recommendation engine computes a score for each of the programs that are to be broadcast. The recommendation engine then takes this score and computes a relative score that provides a measure of how one particular program relates all of the other programs that are to be broadcast. One way of computing a relative score is to divide each program's individual score by the highest score found for any program in the forthcoming schedule. To facilitate this calculation, the recommendation engine can, at the conclusion of the download and metadata matching processes, determine the highest score and save this score in a global location, e.g. in a particular user's user preference file. As further individual scores are computed for each of the programs for each of the users, each program's relative score can be computed as well.

It can be advantageous to translate each program's relative score into a useful visual display that can be readily utilized by a user for selecting programs. For example, a star rating system can be utilized. One way of implementing a star rating system can be as follows. Programs that receive a negative score (and hence are not desirable from a user's standpoint) will not receive a recommendation star. Similarly, programs that receive scores that are less than typically about half of the highest score will not receive a recommendation star. Various thresholds can be used to ascertain how many stars a program is to receive. It can be desirable for the thresholds associated with the different star ratings to be user programmable so that individual users can define how stars are to be assigned. As an example, consider the following exemplary threshold settings and associated stars:

| | |
|---|---|
| 0-50% | No star |
| (and negative scores) | |
| 50-60% | One star |
| 60-70% | Two stars |
| 70-80% | Three stars |
| 80-90% | Four stars |
| 90-100% | Five stars |

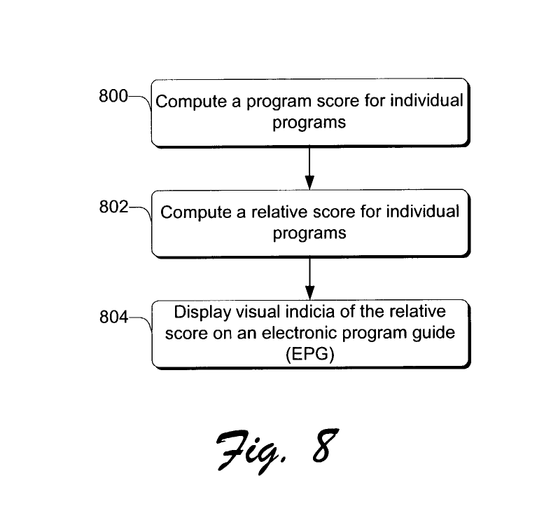

FIG. 8 is a flow diagram that describes steps in a method in accordance with one embodiment. The method can be implemented in any suitable hardware, software, firmware or combination thereof In the illustrated example, the method can be implemented in connection with an EPG system such as the one discussed above.

Step 800 computes a program score for individual programs that are to be represented in an electronic program guide. Program scores can be computed in any suitable way. One way of computing program scores is described in this document and the others that have been incorporated by reference above. In those systems, computation of the program scores is performed by a recommendation engine that can compute scores as a function of metadata that describes media content and preferences that have been expressed by users in terms of a user preference file. Step 802 computes, from the program score for each program, a relative score for that program. The relative score provides a measure of how well a particular program relates to the other programs that are to be broadcast. One way of computing a relative score is described just above. Step 804 then displays visual indicia of the relative score on an EPG. This step can be implemented by rendering an EPG and providing, within or associated with individual cells of the EPG, the visual indicia for an associated program. Any suitable visual indicia can be utilized. For example, the visual indicia can comprise a number that reflects the relative score, one or more symbols (such as a star or a number of stars), or a color that is associated with or used to accent individual cells (e.g. green cells indicate highly recommended programs, yellow cells indicate program of moderate or little interest, and red cells indicate programs that are not recommended).

Demographic Stereotypes

Demographic stereotypes can be used to provide powerful tools for enhancing the user's experience in the context of electronic program guides. Additionally, demographic stereotypes can be used to provide tools for businesses and other information providers to leverage and efficiently use their resources to tailor the information they provide to various users while, at the same time preserve the privacy of the users to which such information is provided.

A demographic stereotype is simply a combination of demographic attributes. The demographic attributes are selected from a collection of demographic axes that collectively define the demographic space in which stereotypes exist. As an example, consider the following demographic axes that define an exemplary demographic space within which stereotypes can be defined:

Gender

Age

Marital Status

Household Income

Ethnic Origin

Religion

Occupation

Each of the demographic axes includes multiple attributes or characteristics individual ones of which can be selected to define a stereotype. As an example, consider the following attributes or characteristics for each of the demographic axes listed above:

Gender

Unspecified

Male

Female

Male_Homosexual

Female_Homosexual

Other

Age

Unspecified

0-5

6-12

13-19

20-34

35-54

55+

Marital Status

Unspecified

Single

Married_No_Children

Married_With_Children

Single_With_Children

Household Annual Income

Unspecified

0-34K$

35-69K$

70-139K$

140+K$

Education

Unspecified

Low (Equates to not attending High School)

Average (Equates to something like High School attendance)

High (Equates to the equivalent of a College education)

Ethnic Origin

Unspecified

Western_European (Includes English, French, German, Dutch, Italian, Scandinavian, Irish, Scottish, and Welsh)

Eastern_European (Includes Russian, Polish, and Hungarian)

Latino (Includes Spanish, South American, Mexican, Chicano, Puerto Rican, and Cuban)

African (Includes African)

Indian_Asian (Includes Asian Indian)

Far_Eastern (Includes Chinese, Japanese, Philippine, Korean, and Vietnamese)

Arabic (Includes Arabic, and Pakistani)

Original_Peoples (Includes Native American, Aboriginal, Icelandic, Eskimo, Alaskan, Hawaiian, and Pacific Islander)

Other

Religion

Unspecified

Christian

Jewish

Buddhist

Islamic

Hindu

Agnostic

Atheist

Other

Occupation

Unspecified

Not_Employed

Manual_Worker (Includes construction worker, factory worker, and store worker)

Office_Worker (Includes clerks, realtors, and administration workers)

Crafts_Or_Skill_Worker (Includes Nurses, carpenters, Policemen, Firemen, and artists)

Profession_Worker (Includes doctors, architects, and surveyors)

Technologist (Includes engineers and scientists)

Manager (Includes middle and senior managers)

Other

A valid stereotype comprises any combination of attribute selections from the various demographic axes. It is not necessary that attributes for every axis be specified. For example, it is acceptable to specify “unspecified” for a particular axis. As an example, consider the following stereotype:

Male—Unspecified—Single—Unspecified—Unspecified—Unspecified—Unspecified—Unspecified

This stereotype can simply be specified as “Male—Single”. In this example, the number of discrete stereotypes is very large since it includes all possible answers on each axis. In the particular implementation, the number of discrete stereotypes is:

6×7×5×5×4×10×9×9=3,402,000.

Given the large number of discrete stereotypes, it can be advantageous to keep the number of possible stereotypes at a reasonably manageable number. Thus, in order to keep the number of stereotypes manageable, various stereotypes can be grouped together depending on the particular application. Various techniques can be used to group stereotypes together. For example, past data that pertains to the stereotypes can be studied (e.g. which types of programs particular stereotypes tend to prefer) and the stereotypes can be logically grouped together in terms of these preferences. Any suitable method can be used to determine how to group stereotypes together. One technique is to use collaborative filtering techniques in connection with a very large sample of users. One example of why it is desirable to group stereotypes together is provided below in the section entitled “Seed User Preference File.”

In accordance with one embodiment, a stereotype that is specific to a particular user can be stored in their User Preference File. Typically, the user can select a stereotype by selecting items on individual demographic axes at the time the user sets up the EPG system. The user is free, however, to change their selections at any time. Once the user's stereotype is acquired by the system, the system can begin to provide stereotype-associated services to the user.

Seed User Preference File

Recall that a user's User Preference File is essentially a list of program attributes that the user likes (or dislikes in the case of a negative score against an attribute). As well as attributes such as names of actors and genres, the User Preference File can also contain things such as preferences for the year the program was made and preferences for higher critic review ratings.

While some of the information contained in the User Preference File is specific to a particular user's tastes or preferences, some of the information can likely be common to individuals within a particular demographic stereotype. For example, highly educated males between ages 35-54 may tend to prefer informative news programs and political commentary. Females between ages 6-12 may tend to prefer entertainment programs that include dancing and singing.

Given that individuals within a particular demographic group or stereotype tend to like similar program attributes, a seed User Preference File can be provided that is tailored to a particular stereotype or stereotypes. This essentially provides a starting point from which the individual can make adjustments to fine tune their User Preference File to their own specific preferences. A seed User Preference File can include such things as actor names, genres and a variety of pre-defined attributes that are likely to reflect, in general, the overall preferences of the stereotype.

Having a seed User Preference File can be advantageous for a couple of different reasons. For example, the user can be relieved from a great deal of the up front work defining their User Preference File. Additionally, the program recommendation system can immediately start recommending programs to the user that are likely, given the soundness of the demographic assumptions, to meet with the user's approval.

FIG. 9 is a flow diagram that describes steps in a method in accordance with one embodiment. The method can be implemented in any suitable hardware, software, firmware or combination thereof. In the illustrated example, the method can be implemented in connection with an EPG system such as the one discussed above.

Step 900 ascertains a user's stereotype. This step can be accomplished in any suitable way. For example, when a user initially sets up their EPG system, the system can query the user as to their various demographic axis attributes. By answering a series of simple questions, the system can quickly ascertain the user's stereotype. Step 902 select a seed user preference file based on the user's stereotype. One way that this step can be implemented is as follows. The server can provide to the client device multiple different seed user preference files from which the client device can choose. By using demographic grouping techniques, the number of seed files can be maintained at a manageable number. Once the client system ascertains the user's stereotype, the system can simply select the appropriate seed user preference file for the user. In this manner, the user's information (i.e. stereotype) is maintained on the client device and is not provided to an external server.

Once the appropriate seed user preference file is selected, step 904 uses the selected seed user preference file to make program recommendations to the user. Examples of how this can be done are given above. Specific examples of how program recommendation can take place and exemplary displays that can be generated by the system are described in application Ser. No. ______, bearing Attorney Docket No. ms 1-1204, incorporated by reference above.

Collaborative Filtering

In accordance with one embodiment, collaborative filtering techniques can be utilized to generate multiple dependency networks. The dependency networks can be generated for each of the stereotypes or stereotype groups. Once a particular user's stereotype or stereotype group is ascertained, an associated dependency network can be used by the system as a basis for recommending programs to a user.

Collaborative filtering systems can be utilized to predict the preferences of a user. The term “collaborative filtering” refers to predicting the preferences of a user based on known attributes of the user, as well as known attributes of other users. For example, a preference of a user may be whether they would like to watch the television show “I Love Lucy”, and the attributes of the user may include their age, gender, and income. In addition, the attributes may contain one or more of the user's known preferences, such as their dislike of another television show. A user's preference can thus be predicted based on the similarity of that user's attributes to other users. For example, if all users over the age of 50 with a known preference happen to like “I Love Lucy” and if that user is also over 50, then that user may be predicted to also like “I Love Lucy” with a high degree of confidence.

Collaborative filtering techniques and methodologies are described in the following references, the disclosures of which are incorporated by reference herein: U.S. Pat. Nos. 5,704,017; 6,006,218; 6,321,225; 6,330,563; 6,336,108; and 6,345,265.

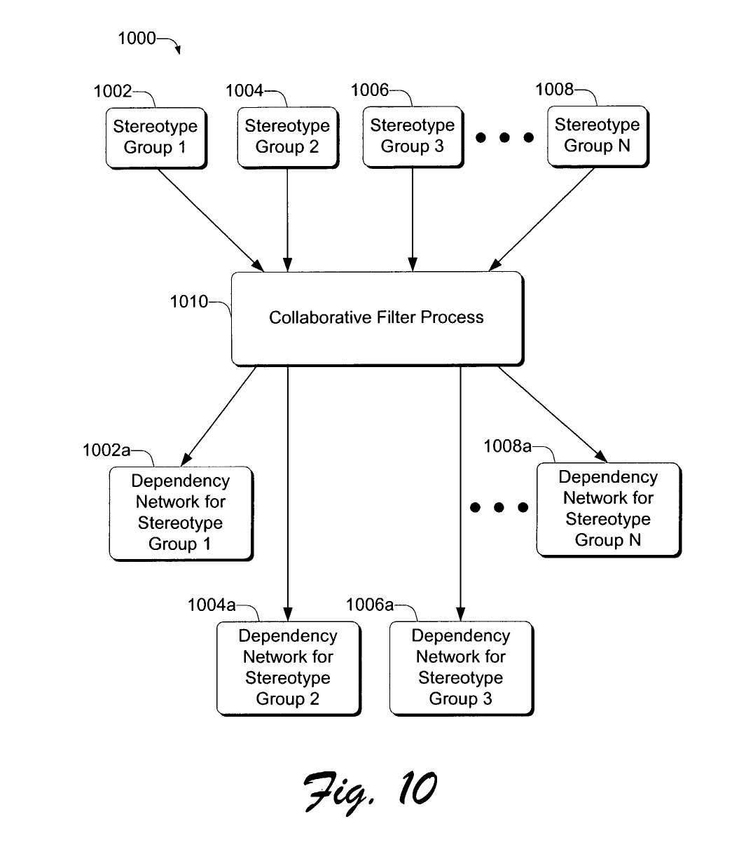

In the illustrated and described embodiment, a server builds multiple dependency networks that can be provided to the various client devices for use. As an example, consider FIG. 10. There, a server-side system 1000 includes a collaborative filter process 1010 that processes information from multiple users to provide the various dependency networks that can be used by the client devices. Here, process 1010 processes information associated with each of a number of stereotype groups 1002, 1004, 1006, and 1008 that include individual stereotypes, to provide, for each stereotype group, an associated dependency network 1002a, 1004a, 1006a, and 1008a respectively.

Once the dependency networks for the individual stereotype groups have been generated, the individual dependency networks can be downloaded to the client. The user can then either select a dependency network that best represents themselves, or the system can automatically select a dependency network that is associated with the user's specific stereotype. Advantageously, the information about which dependency network was selected for the user can be maintained on the client such that it is not provided to the server or any other entities. Accordingly, the client's privacy is maintained.

As with the seed user preference files above, considerable grouping of stereotypes can be employed to dramatically reduce the number of associated dependency networks. In practice the number of dependency networks can be kept down to double digits.

As an implementation example, the dependency networks can be built by using a population of users who have voluntarily decided to opt-in to provide information to the server. Typically this user opt-in will be in return for some monetary compensation for the loss of privacy. When a user opts-in, they also provide demographic information such as their particular stereotype. This provides a means by which the different dependency networks can be related to the different stereotypes.

Once the appropriate dependency network has been selected on the client, it can be used to generate program recommendations. One way that this can be accomplished is that software executing on the client (such as the recommendation engine) can derive, from the user viewer log, which programs the particular user likes to watch. The dependency network can then be used to recommend other programs. For example, the dependency network can answer the question “if the user likes this show, what other shows is the user likely to enjoy?”. For each of the top “n” shows that the client has noticed that the user likes, the client can provide the dependency network with the title of the show and receive back a list of recommended shows. The accuracy of the recommendations will likely be good because the dependency network was built from users with the same stereotype as the particular user.

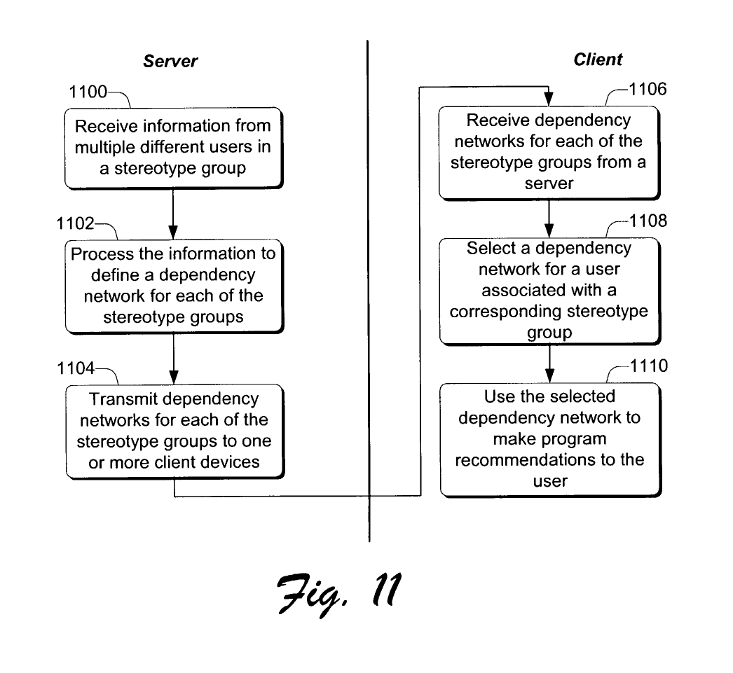

FIG. 11 is a flow diagram that describes steps in a method for providing dependency networks for a client device to use, in accordance with one embodiment. The method can be implemented in any suitable hardware, software, firmware or combination thereof. In the illustrated example, the method can be implemented in connection with an EPG system such as the one discussed above. Notice that the method is described in terms of steps that take place at the server and steps that take place at the client.

Step 1100 receives information from multiple different users in a stereotype group. Typically, this step can be implemented by the server collecting information from the individual users. Step 1102 processes the information to define a dependency network for each of the stereotype groups. This method can be implemented using any suitable collaborative filtering techniques. Examples of collaborative filtering techniques are described in the patents incorporated by reference above. After the dependency networks are defined, step 1104 transmits the dependency networks for each of the stereotype groups to one or more client devices. Advantageously, as noted above, this can ensure that a particular user's privacy is maintained because they do not have to provide their personal information to the server.

Step 1106 receives, at the client device, the dependency networks that have been transmitted by the server. Step 1108 selects a dependency network for a user who is associated with a corresponding stereotype group. Step 1110 uses the selected dependency network to make program recommendations to the user. The dependency network can be incorporated into and used by a recommendation engine such the one described above.

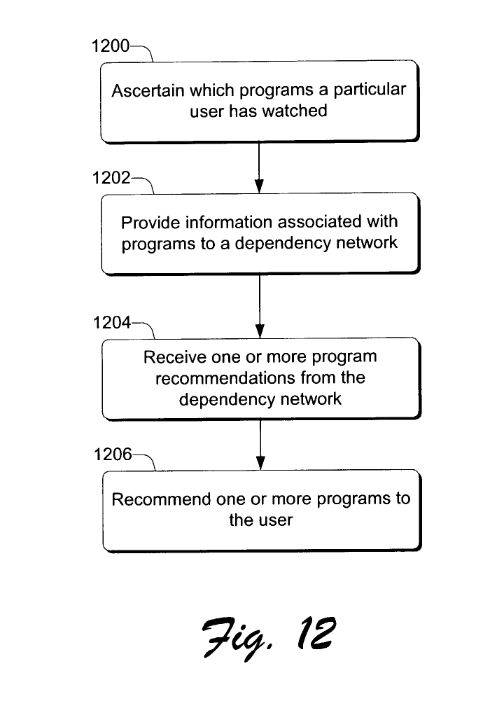

FIG. 12 is a flow diagram that describes steps in a method for using dependency networks to make program recommendations. The method can be implemented in any suitable hardware, software, firmware or combination thereof. In the illustrated example, the method can be implemented in connection with an EPG system such as the one discussed above. The steps of this method essentially expand upon the processing that takes place at step 1110 in FIG. 11.

Step 1200 ascertains which programs a particular user has watched. This can be implemented by examining the viewer log associated with the users of the client device. Step 1202 provides information associated with the programs to a dependency network that is associated with the user. In this example, the dependency network is the network that was selected to correspond with the user's stereotype or stereotype group. Any suitable program-associated information can be provided to the dependency network. For example, the information can comprise a program's title. Alternately, the information can comprise information about the program's genre, actors, story line and the like. Step 1204 receives one or more program recommendations from the dependency network. This step is implemented by the dependency network processing the information provided at step 1202 to provide the recommendations. Step 1206 then recommends one or more programs to the user.

Dependency networks can provide a powerful tool for enhancing the user's viewing experience. By taking into account the preferences and dependencies of other similarly situated users within a particular stereotype group, recommendations can be made to particular users who are members of the stereotype group. These recommendations will typically have a good chance of being accurate because they are made with the user's stereotype group in mind.

Targeted Advertising

Stereotype groups can be used in the context of an EPG system to facilitate the process by, and efficiency with, which advertisements are provided to various users. This can enhance not only the user's experience by exposing them to advertisements for products and services that they are likely to be particularly interested in, but it can more efficiently use the resources of the businesses that offer such products and services.

Consider, for example, the advertising model that presently exists in the context of television viewing. Typically, a wide variety of advertisements for products and services are simply ‘scatter-gun’ broadcast to a wide range of potential viewers. In this model, even people for whom the advertisement has no relevance are still bombarded with it. For example, housewives are typically forced to watch advertisements for tools and building materials. Likewise, men may be forced to watch advertisements for female hygiene products. Needless to say, a better advertising model needs to be found, particularly in light of the fact that client devices are becoming intelligent enough to strip out commercials.

Targeted advertising can provide a solution for the “scatter gun” advertising problem that currently exists. By specifically targeting particular groups of consumers with commercials that are likely to be of interest to them, the interests of not only the consumer, but the advertiser as well are better served. One of the challenges with targeted advertising, however, pertains to collecting information about individual consumers in such a way that maintains their privacy. For example, some believe that in order to have an effective targeted advertising system, a user needs to provide their personal information to a server so that the server can efficiently direct advertisements to the user. Such need not, however, be the case.

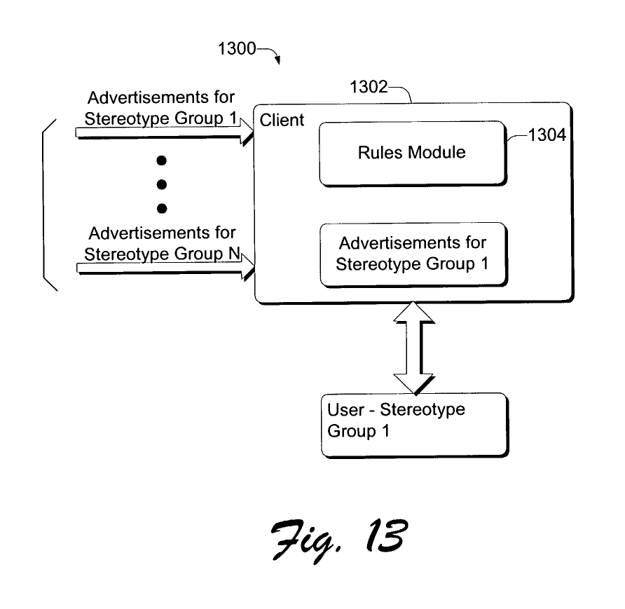

As but one example, consider FIG. 13 which shows a system 1300 in accordance with one embodiment in which targeted advertising can be used in a manner that protects the user's privacy. Here, multiple different channels of advertisements are available or otherwise broadcast to a client 1302. Each of the channels contains advertisements that are targeted at a particular stereotype group. For example, one channel might broadcast advertisements that are directed to a stereotype group that includes middle-aged women with college educations, while another channel might broadcast advertisements that are directed to a stereotype group that includes teenage boys, and so on. By virtue of the fact that the client device 1302 knows the stereotype groups of its individual users, the client device can select an appropriate channel that is associated with the particular stereotype groups of its users. The client device can then record the commercials and present them to the appropriate users at the appropriate times. To facilitate commercial presentation, the client device can include a rules module 1304 that defines parameters associated with how and when the commercials are to be presented. For example, the rules module might have a rule that ten advertisements need to be shown every hour. The rules module can ensure that the client device presents the commercials at the appropriate times and with the appropriate frequency. The rules module can also serve as the foundation by which various business models that pertain to the advertisements can be provided.

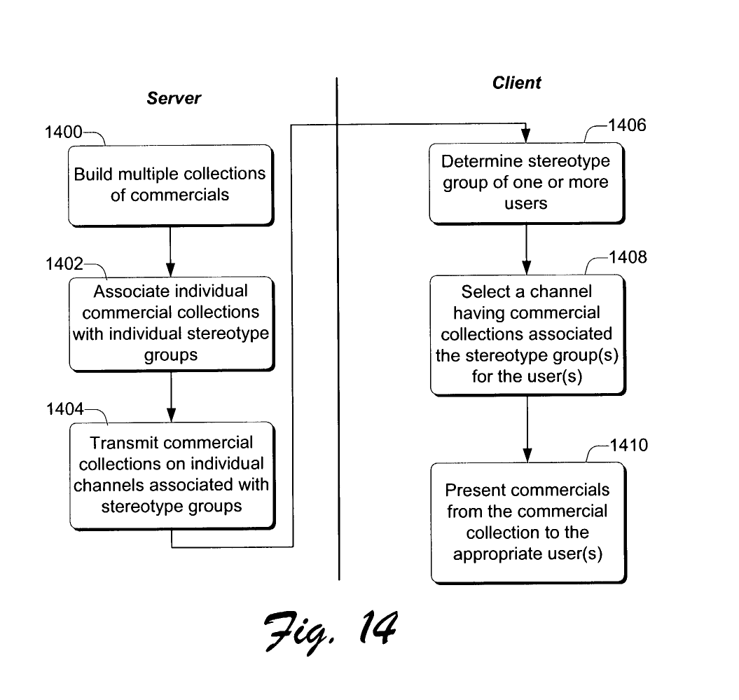

FIG. 14 is a flow diagram that describes steps in a method for targeting advertisements or commercials to particular users. The method can be implemented in any suitable hardware, software, firmware or combination thereof. In the illustrated example, the method can be implemented in connection with an EPG system such as the one discussed above. Notice that the method includes steps that are performed by the server and steps that are performed by the client device.

Step 1400 builds multiple collections of commercials and step 1402 associates individual commercial collections with individual stereotype groups. The commercials in a commercial collection for a particular stereotype group are selected in such a way that they have a high degree of likelihood of appealing to the members of the stereotype group. For example if the stereotype group includes middle-aged women with college educations, then the commercials are selected so as to appeal to this group. Step 1404 transmits commercial collections on individual channels associated with the stereotype groups. Thus, each channel on which the commercial collections are broadcast is associated with a different stereotype group.

Step 1406 determines a stereotype group of one or more users of a client device. This step can be implemented at the client device by, for example, having the user answer a short series of questions that enables the client device to ascertain the user's stereotype group. Step 1408 selects a channel having commercial collections associated the stereotype group(s) for the user(s). Thus, if one of the users of the client device is a middle-aged women with a college education, then this step would select the channel having a commercial collection that is associated with the stereotype group that contains middle-aged women with college educations. Step 1410 presents the commercials from the particular commercial collection to the appropriate users. This step can be implemented by recording the commercials and then presenting the commercials in accordance with any rules that govern their presentation. The system can ascertain who its present users are by having the users identify themselves when they begin viewing programs on the client device. In this manner, commercials can be very specifically targeted to particular users within a stereotype group while at the same time preserving the user's privacy.

Commercials can also be targeted at particular users in other ways as well. As an example, consider the following. In much the same way that programs are described by a comprehensive schema of attributes, individual commercials can be associated with attributes that pertain to the stereotypes to which it is targeted, e.g. by tagging the commercials with the attributes. For example, the commercial can be tagged with one or more of the attributes from the demographic axes described above. The commercials are then broadcast to the client device and recorded. In much the same way that the client device calculates a score for programs based on the program attributes and User Preference Files, the client can ascertain whether any of the attributes for the commercials match any of the user's stereotype attributes. If matching attributes are found between individual commercials and users of the client device, a relevancy score can be calculated for the commercial. The commercials with the highest relevancy scores can then be shown to the appropriate users in accordance with any rules that govern their presentation.

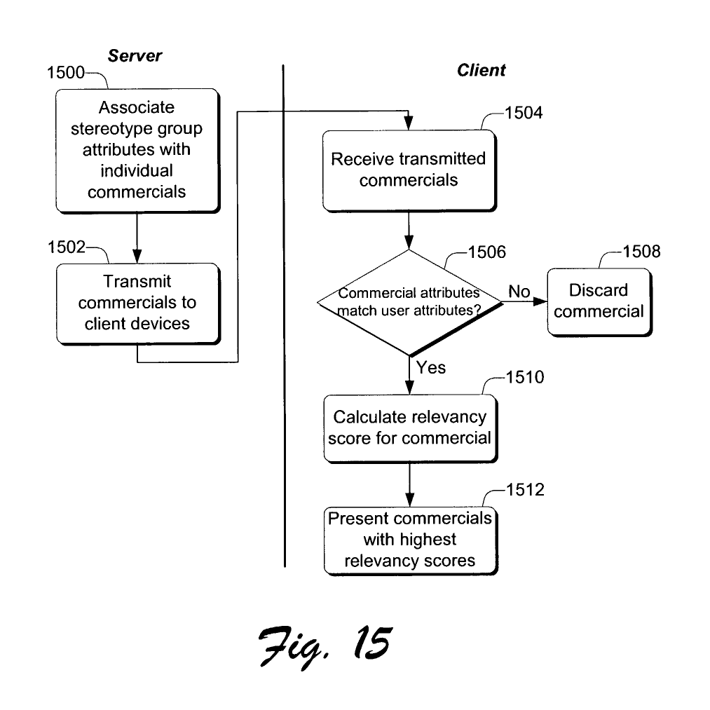

FIG. 15 is a flow diagram that describes steps in a method for targeting advertisements or commercials to particular users. The method can be implemented in any suitable hardware, software, firmware or combination thereof. In the illustrated example, the method can be implemented in connection with an EPG system such as the one discussed above. Notice that the method includes steps that are performed by the server and steps that are performed by the client device.

Step 1500 associates stereotype group attributes with individual commercials. Stereotype group attributes can comprise any suitable attributes, examples of which are given above. The attributes that are associated with a particular commercial are those attributes that comprise the stereotype group or groups at which the commercial is targeted. Step 1502 transmits the commercials to the client devices. Step 1504 receives that transmitted commercials. The commercials can typically be stored on the client device for further processing. Step 1506 determines whether attributes associated with individual commercials match any of the stereotype attributes associated with the client's individual users. If there are no matches, then step 1508 can discard the commercial. If, on the other hand, there is a match between the attributes associated with an individual commercial and one or more of the stereotype attributes associated with a user, step 1510 calculates a relevancy score for the commercial. Any suitable method can be utilized to calculate a relevancy score. Examples of how relevancy scores can be calculated for individual programs are given above. Similar principles can be utilized to calculate scores for the commercials. After the relevancy scores are calculated for the commercials, step 1512 presents commercials with the highest relevancy scores. These commercials are desirably presented to the appropriate users in accordance with any rules that govern their presentation. The system can ascertain who its present users are by having the users log in when they begin viewing programs on the client device. In this manner, commercials can be very specifically targeted to particular users within a stereotype group while at the same time preserving the user's privacy.

Stereotypes can thus be used to build a very effective targeted advertising model. That model can be further refined by taking into account viewing habits that are learned from the user's viewing log, and by looking at the program attributes in the User Preference File. For example, it may be that the system has established the fact that the user likes golf programs, so it is therefore appropriate to show that user golf-related commercials.

Configuring User Interface Options Based on Stereotypes

Stereotypes can also have a correlation with respect to the way that a user interface is set up and presented to a user. For example, different types of people, i.e. different stereotypes, tend to like to have their User Interface options set differently. In the context of user interfaces for electronic program guides, a person with a higher level of education tends, for example, to like to have more information displayed about the programs so that they can read comprehensive information about the programs and make more informed choices. The same is true for people who are involved in technical occupations such as engineers and scientists.

Additionally, stereotypes can also be used to drive the appearance or ‘skin’ of the user interface. For example, teenagers tend to prefer more eccentric user interfaces with hip colors, controls and buttons. Middle aged people tend to like more conservative user interfaces with less eccentric options.

Accordingly, when initially configuring a user interface, the system can take into account the various users’ stereotypes and select the amount of information it displays as well as the initial appearance or ‘skin’ for the user interface. The user is then free to tailor the user interface to fit with their particular individual tastes. As with the stereotype, any detailed adjustments to the user interface options can be stored in the User Preference File.

Celebrity Stereotypes

Various creative and commercial possibilities can also be provided by using stereotypes. For example, User Preference Files that have been defined by interesting famous people can be offered for sale so that individual users can enjoy programs that are enjoyed by their favorite celebrity.

Exemplary Computer Environment

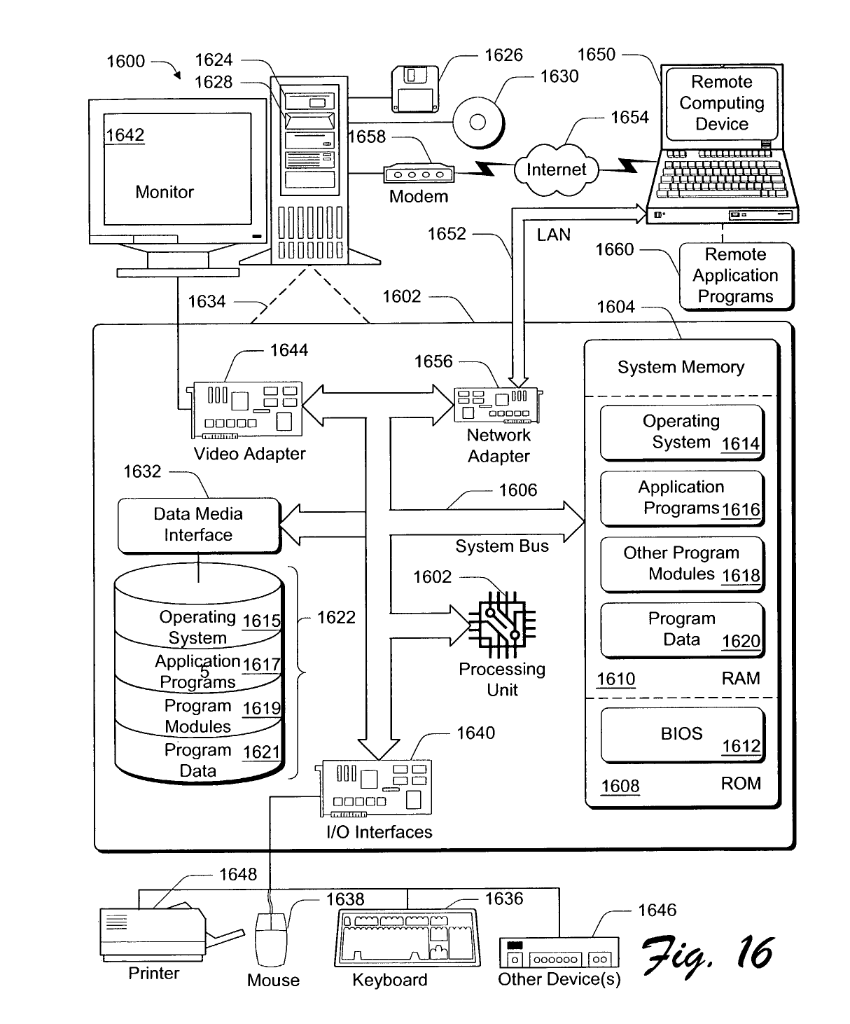

The various components and functionality described herein can be implemented with a number of individual computers that serve as client devices. FIG. 16 shows components of a typical example of such a computer generally at 1600. The components shown in FIG. 16 are only examples, and are not intended to suggest any limitations as to the scope of the claimed subject matter.

Generally, various different general purpose or special purpose computing system configurations can be used. Examples of well known computing systems, environments, and/or configurations that may be suitable for use in implementing the described embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Various functionalities of the different computers can be embodied, in many cases, by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 16, the components of computer 1600 may include, but are not limited to, a processing unit 1602, a system memory 1604, and a system bus 1606 that couples various system components including the system memory to the processing unit 1602. The system bus 1606 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Computer 1600 typically includes a variety of computer-readable media. Computer-readable media can be any available media that can be accessed by computer 1600 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1600. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 1604 includes computer storage media in the form of volatile and/or nonvolatile memory such as read only memory (ROM) 1608 and random access memory (RAM) 1610. A basic input/output system 1612 (BIOS), containing the basic routines that help to transfer information between elements within computer 1600, such as during start-up, is typically stored in ROM 1608. RAM 1610 typically contains data and/or program modules that are immediately accessible to and/or presently being operated on by processing unit 1602. By way of example, and not limitation, FIG. 16 illustrates operating system 1614, application programs 1616, other program modules 1618, and program data 1620.

The computer 1600 may also include other removable/non-removable, volatile/nonvolatile computer storage media. By way of example only, FIG. 16 illustrates a hard disk drive 1622 that reads from or writes to non-removable, nonvolatile magnetic media, a magnetic disk drive 1624 that reads from or writes to a removable, nonvolatile magnetic disk 1626, and an optical disk drive 1628 that reads from or writes to a removable, nonvolatile optical disk 1630 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1622 is typically connected to the system bus 1606 through a non-removable memory interface such as data media interface 1632, and magnetic disk drive 1624 and optical disk drive 1628 are typically connected to the system bus 1606 by a removable memory interface such as interface 1634.

The drives and their associated computer storage media discussed above and illustrated in FIG. 16 provide storage of computer-readable instructions, data structures, program modules, and other data for computer 1600. In FIG. 16, for example, hard disk drive 1622 is illustrated as storing operating system 1615, application programs 1617, other program modules 1619, and program data 1621. Note that these components can either be the same as or different from operating system 1614, application programs 1616, other program modules 1618, and program data 1620. Operating system 1615, application programs 1617, other program modules 1619, and program data 1621 are given different numbers here to illustrate that, at a minimum, they are different copies. A user may enter commands and information into the computer 1600 through input devices such as a keyboard 1636 and pointing device 1638, commonly referred to as a mouse, trackball, or touch pad. Other input devices (not shown) may include a microphone, joystick, game pad, satellite dish, scanner, or the like. These and other input devices are often connected to the processing unit 1602 through an input/output (I/O) interface 1640 that is coupled to the system bus, but may be connected by other interface and bus structures, such as a parallel port, game port, or a universal serial bus (USB). A monitor 1642 or other type of display device is also connected to the system bus 1606 via an interface, such as a video adapter 1644. In addition to the monitor 1642, computers may also include other peripheral output devices 1646 (e.g., speakers) and one or more printers 1648, which may be connected through the I/O interface 1640.

The computer may operate in a networked environment using logical connections to one or more remote computers, such as a remote computing device 1650. The remote computing device 1650 may be a personal computer, a server, a router, a network PC, a peer device or other common network node, and typically includes many or all of the elements described above relative to computer 1600. The logical connections depicted in FIG. 16 include a local area network (LAN) 1652 and a wide area network (WAN) 1654. Although the WAN 1654 shown in FIG. 16 is the Internet, the WAN 1654 may also include other networks. Such networking environments are commonplace in offices, enterprise-wide computer networks, intranets, and the like.

When used in a LAN networking environment, the computer 1600 is connected to the LAN 1652 through a network interface or adapter 1656. When used in a WAN networking environment, the computer 1600 typically includes a modem 1658 or other means for establishing communications over the Internet 1654. The modem 1658, which may be internal or external, may be connected to the system bus 1606 via the I/O interface 1640, or other appropriate mechanism. In a networked environment, program modules depicted relative to the computer 1600, or portions thereof, may be stored in the remote computing device 1650. By way of example, and not limitation, FIG. 16 illustrates remote application programs 1660 as residing on remote computing device 1650. It will be appreciated that the network connections shown are exemplary and other means of establishing a communications link between the computers may be used.

Conclusion

Various methods and systems make use of demographic stereotypes to provide powerful tools for enhancing the user's experience in the context of electronic program guides (EPGs).

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. A method comprising:
selecting one or more demographic attributes to define a stereotype for a user of a client device having an electronic program guide system thereon; and
providing one or more stereotype-associated services to the user via the electronic program guide system, at least one service comprising a program-recommendation service in which programs are recommended based on the user's stereotype.

2. The method of claim 1, wherein the act of providing comprises displaying targeted advertising for the user based on the user's stereotype.

3. The method of claim 1, wherein the act of providing comprises automatically configuring a user interface of the client device based upon the user's stereotype.

4. One or more computer-readable media having computer-readable instructions thereon which, when executed by one or more processors, cause the processors to:
select one or more demographic attributes to define a stereotype for a user of a client device having an electronic program guide system thereon; and
provide one or more stereotype-associated services to the user via the electronic program guide system, at least one service comprising a program-recommendation service in which programs are recommended based on the user's stereotype.

5. The one or more computer-readable media of claim 4, wherein the instructions cause the one or more processors to provide the one or more stereo type-associated services by targeting advertising for the user based on the user's stereotype.

6. The one or more computer-readable media of claim 4, wherein the instructions cause the one or more processors to provide the one or more stereo type-associated services by automatically configuring a user interface of the client device based upon the user's stereotype.

7. The one or more computer-readable media of claim 4, wherein the instructions cause the one or more processors to provide the one or more stereo type-associated services by recommending one or more programs based on the user's stereotype and by targeting advertising for the user based on the user's stereotype.

8. A client device comprising:
one or more processors;
one or more computer-readable having computer-readable instructions thereon which, when executed by one or more processors, cause the one or more processors to:
select one or more demographic attributes to define a stereotype for a user of a client device having an electronic program guide system thereon; and
provide one or more stereotype-associated services to the user via the electronic program guide system, at least one service comprising a program-recommendation service in which programs are recommended based on the user's stereotype.

9. The client device of claim 8, wherein the instructions cause the one or more processors to provide the one or more stereo type-associated services by targeting advertising for the user based on the user's stereotype.

10. The client device of claim 8, wherein the instructions cause the one 11 or more processors to provide the one or more stereo type-associated services by automatically configuring a user interface of the client device based upon the user's stereotype.

11. A method comprising:
selecting one or more demographic attributes to define a stereotype for a user of a client device having an electronic program guide system thereon;
based on the user's stereotype, selecting a stereotype group that contains other stereotypes; and
providing one or more stereotype group-associated services to the user via the electronic program guide system.

12. The method of claim 11, wherein the act of providing comprises recommending one or more programs based on the user's stereotype group.

13. The method of claim 11, wherein the act of providing comprises displaying targeted advertising for the user based on the user's stereotype group.

14. The method of claim 1 1, wherein the act of providing comprises automatically configuring a user interface of the client device based upon the user's stereotype group.

15. The method of claim 11, wherein the demographic attributes are selected from among a number of different demographic axes, the demographic axes being selected from a group comprising: gender, age, marital status, income, ethnic origin, religion, occupation.

16. One or more computer-readable media having computer-readable instructions thereon which, when executed by one or more processors, cause the one or more processors to execute the method of claim 11.

17. A client device embodying the one or more computer-readable media of claim 16.

18. One or more computer-readable media having computer-readable instructions thereon which, when executed by one or more processors, cause the processors to:
select one or more demographic attributes to define a stereotype for a user of a client device having an electronic program guide system thereon, the demographic attributes being selected from among a number of different demographic axes, the demographic axes being selected from a group comprising: gender, age, marital status, income, ethnic origin, religion, occupation;
based on the user's stereotype, select a stereotype group that contains other stereotypes; and
provide one or more stereotype group-associated services to the user via the electronic program guide system.

19. The one or more computer-readable media of claim 18, wherein the instructions cause the one or more processors to provide the one or more stereotype group-associated services by recommending one or more programs based on the user's stereotype group.

20. The one or more computer-readable media of claim 18, wherein the instructions cause the one or more processors to provide the one or more stereotype group-associated services by displaying targeted advertising for the user based on the user's stereotype group.

21. The one or more computer-readable media of claim 18, wherein the instructions cause the one or more processors to provide the one or more stereotype group-associated services by automatically configuring a user interface of the client device based upon the user's stereotype group.

22. A client device comprising:
one or more processors; and
one or more computer-readable media having computer-readable instructions thereon which, when executed by one or more processors, cause the processors to:
select one or more demographic attributes to define a stereotype for a user of a client device having an electronic program guide system thereon, the demographic attributes being selected from among a number of different demographic axes, the demographic axes being selected from a group comprising: gender, age, marital status, income, ethnic origin, religion, occupation;
based on the user's stereotype, select a stereotype group that contains other stereotypes; and
provide one or more stereotype group-associated services to the user via the electronic program guide system.

23. The client device of claim 22, wherein the instructions cause the one or more processors to provide the one or more stereotype group-associated services by recommending one or more programs based on the user's stereotype group.

24. The client device of claim 22, wherein the instructions cause the one or more processors to provide the one or more stereotype group-associated services by displaying targeted advertising for the user based on the user's stereotype group.

25. The client device of claim 22, wherein the instructions cause the one or more processors to provide the one or more stereotype group-associated services by automatically configuring a user interface of the client device based upon the user's stereotype group.

26. A method comprising:
selecting one or more demographic attributes to define a stereotype for a user of a client device having an electronic program guide system thereon; and
using the user's stereotype to select a seed user preference file for the user, the seed user preference file being configured to be used by the electronic program guide system to make program recommendations to the user.

27. The method of claim 26, wherein the electronic program guide system uses the seed user preference file to make program recommendations by using the seed user preference file to calculate scores associated with programs that are to be represented in the electronic program guide.

28. The method of claim 26, wherein the electronic program guide system uses the seed user preference file to make program recommendations by using the seed user preference file to calculate scores associated with programs that are to be represented in the electronic program guide, the seed user preference file containing data that defines user preferences in terms of one or more attributes that are associated with the programs and attribute values to define the user preferences.

29. The method of claim 28, wherein the attribute values comprise character strings that define individuals associated with the programs.

30. The method of claim 28, wherein the attribute values comprise character strings that define contexts that pertain to individuals associated with the programs.

31. The method of claim 28, wherein the attribute values contain values that indicate an extent to which a user prefers a particular attribute.

32. The method of claim 28, wherein the attribute values contain numerical values that indicate an extent to which a user prefers a particular attribute.

33. One or more computer-readable media having computer-readable instructions thereon which, when executed by one or more processors, cause the processors to:
select one or more demographic attributes to define a stereotype for a user of a client device having an electronic program guide system thereon; and
use the user's stereotype to select a seed user preference file for the user, the seed user preference file being configured to be used by the electronic program guide system to make program recommendations to the user.

34. The one or more computer-readable media of claim 33, wherein the instructions cause the processors to use the seed user preference file to make program recommendations by using the seed user preference file to calculate scores associated with programs that are to be represented in the electronic program guide.

35. The one or more computer-readable media of claim 33, wherein the instructions cause the processors to use the seed user preference file to make program recommendations by using the seed user preference file to calculate scores associated with programs that are to be represented in the electronic program guide, the seed user preference file containing data that defines user preferences in terms of one or more attributes that are associated with the programs and attribute values to define the user preferences.

36. The one or more computer-readable media of claim 35, wherein the attribute values comprise character strings that define individuals associated with the programs.

37. The one or more computer-readable media of claim 35, wherein the attribute values comprise character strings that define contexts that pertain to individuals associated with the programs.

38. The one or more computer-readable media of claim 35, wherein the attribute values contain values that indicate an extent to which a user prefers a particular attribute.

39. The one or more computer-readable media of claim 35, wherein the attribute values contain numerical values that indicate an extent to which a user prefers a particular attribute.

40. A client device comprising:
one or more processors; and
one or more computer-readable media having computer-readable instructions thereon which, when executed by one or more processors, cause the processors to:
select one or more demographic attributes to define a stereotype for a user of a client device having an electronic program guide system thereon; and
use the user's stereotype to select a seed user preference file for the user, the seed user preference file being configured to be used by the electronic program guide system to make program recommendations to the user.

41. The client device of claim 40, wherein the instructions cause the processors to use the seed user preference file to make program recommendations by using the seed user preference file to calculate scores associated with programs that are to be represented in the electronic program guide.

42. The client device of claim 40, wherein the instructions cause the processors to use the seed user preference file to make program recommendations by using the seed user preference file to calculate scores associated with programs that are to be represented in the electronic program guide, the seed user preference file containing data that defines user preferences in terms of one or more attributes that are associated with the programs and attribute values to define the user preferences.

43. The client device of claim 42, wherein the attribute values comprise character strings that define individuals associated with the programs.

44. The client device of claim 42, wherein the attribute values comprise character strings that define contexts that pertain to individuals associated with the programs.

45. The client device of claim 42, wherein the attribute values contain values that indicate an extent to which a user prefers a particular attribute.

46. The client device of claim 42, wherein the attribute values contain numerical values that indicate an extent to which a user prefers a particular attribute.

47. A method comprising:
ascertaining preferences associated with individuals who collectively make up multiple different stereotypes; and
constructing seed user preference files associated with the different stereotypes, the seed user preference files defining program preferences for individuals within a particular stereotypes, the seed user preference files being configured to be used by electronic program guide systems on client devices to make program recommendations to users of the client devices.

48. The method of claim 47 further comprising transmitting to one or more client devices at least one seed user preference file.

49. The method of claim 47 further comprising transmitting to one or more client devices multiple seed user preference files.

50. The method of claim 47, wherein the act of constructing comprises:
grouping multiple stereotypes together to define multiple stereotype groups; and
constructing seed user preference files for the multiple stereotype groups.

51. The method of claim 50 further comprising transmitting to one or more client devices at least one seed user preference file.

52. The method of claim 50 further comprising transmitting to one or more client devices multiple seed user preference files associated with the multiple stereotype groups.

53. One or more computer-readable media having computer-readable instructions thereon which, when executed by one or more processors, cause the one or more processors to implement the method of claim 47.

54. One or more servers embodying the one or more computer-readable media of claim 53.

55. A method comprising:
selecting, in connection with offering electronic program guide services, one or more demographic attributes to define individual stereotypes for various users of the electronic program guide services; and
transmitting data associated with one or more of the individual stereotypes to multiple client devices, the data being useable by the client devices for providing stereotype-associated services to its users, one service comprising a program recommendation service that is based at least in part on a stereotype.

56. The method of claim 55, wherein:
the act of selecting comprises grouping individual stereotypes into individual groups; and
the act of transmitting comprises transmitting data associated with one or more individual stereotype groups to the multiple client devices.

57. The method of claim 55, wherein individual stereotypes comprise demographic attributes that are selected from among a number of different demographic axes, the demographic axes being selected from a group comprising: gender, age, marital status, income, ethnic origin, religion, occupation.

58. The method of claim 55, wherein:
the act of selecting comprises grouping individual stereotypes into individual groups; and
the act of transmitting comprises transmitting data associated with one or more individual stereotype groups to the multiple client devices;
wherein individual stereotypes comprise demographic attributes that are selected from among a number of different demographic axes, the demographic axes being selected from a group comprising: gender, age, marital status, income, ethnic origin, religion, occupation.

59. One or more computer-readable media having computer-readable instructions thereon which, when executed by one or more processors, cause the processors to:
select, in connection with offering electronic program guide services, one or more demographic attributes to define individual stereotypes for various users of the electronic program guide services; and
transmit data associated with one or more of the individual stereotypes to multiple client devices, the data being useable by the client devices for providing stereotype-associated services to its users, one service comprising a program recommendation service that is based at least in part on a stereotype.

60. The one or more computer-readable of claim 59, wherein the instructions cause the one or more processors to:
group individual stereotypes into individual groups; and
transmit data associated with one or more individual stereotype groups to the multiple client devices.

61. The one or more computer-readable of claim 59, wherein individual stereotypes comprise demographic attributes that are selected from among a number of different demographic axes, the demographic axes being selected from a group comprising: gender, age, marital status, income, ethnic origin, religion, occupation.

62. One or more servers embodying the computer-readable media of claim 59.

63. One or more servers comprising:
one or more processors;
one or more computer-readable media having computer-readable instructions thereon which, when executed by one or more processors, cause the processors to:
select, in connection with offering electronic program guide services, one or more demographic attributes to define individual stereotypes for various users of the electronic program guide services; and
transmit data associated with one or more of the individual stereotypes to multiple client devices, the data being useable by the client devices for providing stereotype-associated services to its users, one service comprising a program recommendation service that is based at least in part on a stereotype;
wherein individual stereotypes comprise demographic attributes that are selected from among a number of different demographic axes, the demographic axes being selected from a group comprising: gender, age, marital status, income, ethnic origin, religion, occupation.

64. A method comprising:
generating multiple dependency networks, individual dependency networks being configured to be used for recommending programs for individual users of client devices that embody an electronic program guide system; and
transmitting one or more of the multiple dependency networks to a client device.

65. The method of claim 64, wherein the act of generating comprises generating a dependency network for one or more stereotypes associated with users of the client devices.

66. The method of claim 64, wherein the act of generating comprises generating a dependency network for groups of stereotypes associated with users of the client devices.

67. The method of claim 64, wherein the act of generating comprises generating a dependency network using collaborative filtering techniques.

68. The method of claim 64, wherein:
the act of generating comprises receiving information from multiple different users in multiple different stereotype groups; and
the act of transmitting comprises transmitting the dependency networks for each of the multiple stereotype groups.

69. One or more computer-readable media having computer-readable instructions thereon which, when executed by one or more processors, cause the processors to:
generate multiple dependency networks, individual dependency networks being configured to be used for recommending programs for individual users of client devices that embody an electronic program guide system; and
transmit one or more of the multiple dependency networks to a client device.

70. The one or more computer-readable of claim 69, wherein the one or more instructions cause the one or more processors to generate a dependency network for one or more stereotypes associated with users of the client devices.

71. The one or more computer-readable of claim 69, wherein the one or more instructions cause the one or more processors to generate a dependency network for groups of stereotypes associated with users of the client devices.

72. One or more servers embodying the one or more computer-readable of claim 69.

73. A method comprising:
receiving, with a client device embodying an electronic program guide system, multiple dependency networks, individual dependency networks being configured to be used by the client device to recommend programs for its users;
selecting a dependency network for one or more users of the client device; and
using the selected dependency network to make program recommendations, via the electronic program guide system, for the one or more users.

74. The method of claim 73, wherein individual dependency networks are associated with one or more stereotypes, and the act of selecting comprises selecting a dependency network that is associated with a stereotype that corresponds to the one or more users.

75. The method of claim 73, wherein individual dependency networks are associated with stereotype groups, and the act of selecting comprises selecting a dependency network that is associated with a stereotype group that corresponds to a stereotype of the one or more users.

76. The method of claim 73, wherein the act of using comprises:
ascertaining which programs a particular user has watched;
providing information associated with programs the user has watched to the selected dependency network;
receiving one or more program recommendations from the selected dependency network; and
recommending the one or more programs to the one or more users.

77. The method of claim 76, wherein the act of ascertaining comprises examining a viewer log associated with the user.

78. One or more computer-readable media having computer-readable instructions thereon which, when executed by one or more processors, cause the one or more processors to implement the method of claim 73.

79. A client device comprising:
one or more processors; and
one or more computer-readable media having computer-readable instructions thereon which, when executed by one or more processors, cause the processors to:
receive, with a client device embodying an electronic program guide system, multiple dependency networks, individual dependency networks being configured to be used by the client device to recommend programs for its users;
select a dependency network for one or more users of the client device;
use the selected dependency network to make program recommendations, via the electronic program guide system, for the one or more users.

80. The client device of claim 79, wherein individual dependency networks are associated with one or more stereotypes, and the instructions cause the one or more processors to select a dependency network that is associated with a stereotype that corresponds to the one or more users.

81. The client device of claim 79, wherein individual dependency networks are associated with stereotype groups, and the instructions cause the one or more processors to select a dependency network that is associated with a stereotype group that corresponds to a stereotype of the one or more users.

82. A method comprising:
building multiple collections of commercials;
associating individual commercial collections with one or more stereotypes; and
transmitting the commercial collections on individual channels associated with the one or more stereotypes.

83. The method of claim 82, wherein the act of associating the individual commercial collections comprises associating the collections with individual stereotype groups, individual stereotype groups comprising multiple different stereotypes.

84. The method of claim 82, wherein stereotypes are defined by demographic attributes that are selected from among a number of different demographic axes, the demographic axes being selected from a group comprising: gender, age, marital status, income, ethnic origin, religion, occupation.

85. The method of claim 82, wherein the act of associating the individual commercial collections comprises associating the collections with individual stereotype groups, individual stereotype groups comprising multiple different stereotypes, stereotypes being defined by demographic attributes that are selected from among a number of different demographic axes, the demographic axes being selected from a group comprising: gender, age, marital status, income, ethnic origin, religion, occupation.

86. One or more computer-readable media having computer-readable instructions thereon which, when executed by one or more processors, cause the one or more processors to implement the method of claim 82.

87. One or more servers comprising:
one or more processors; and
one or more computer-readable media having computer-readable instructions thereon which, when executed by one or more processors, cause the processors to:
build multiple collections of commercials;
associate individual commercial collections with one or more stereotypes; and
transmit the commercial collections on individual channels associated with the one or more stereotypes.

88. The one or more servers of claim 87, wherein the instructions cause the one or more processors to associate the individual commercial collections with individual stereotype groups, individual stereotype groups comprising multiple different stereotypes.

89. The one or more servers of claim 87, wherein stereotypes are defined by demographic attributes that are selected from among a number of different demographic axes, the demographic axes being selected from a group comprising: gender, age, marital status, income, ethnic origin, religion, occupation.

90. The one or more servers of claim 87, wherein the instructions cause the one or more processors to associate the individual commercial collections with individual stereotype groups, individual stereotype groups comprising multiple different stereotypes, wherein stereotypes are defined by demographic attributes that are selected from among a number of different demographic axes, the demographic axes being selected from a group comprising: gender, age, marital status, income, ethnic origin, religion, occupation.

91. A method comprising:
determining a stereotype associated with one or more users of a client device embodying an electronic program guide system;
selecting a channel having commercial collections associated with the at least one determined stereotype; and
presenting commercials from the commercial collection on the selected channel to one or more of the users.

92. The method of claim 91, wherein the act of determining comprises determining a stereotype group associated with the one or more users.

93. The method of claim 91, wherein the act of determining comprises determining a stereotype group associated with the one or more users, and the act of selecting comprises selecting a channel associated with the stereotype group.

94. The method of claim 91, wherein the act of presenting comprises recording the commercials from the commercial collection and presenting the commercials in accordance with one or more rules that govern the commercials' presentation.

95. The method of claim 91, wherein the act of presenting comprises presenting the commercials in accordance with one or more rules that govern the commercials' presentation.

96. The method of claim 91, wherein the act of presenting comprises ascertaining which users are viewing programs on the client devices and presenting commercials that are appropriate for at least one of the users.

97. One or more computer-readable media having computer-readable instructions thereon which, when executed by one or more processors, implements the method of claim 91.

98. A client device comprising:
one or more processors;
one or more computer-readable media having computer-readable instructions thereon which, when executed by one or more processors, causes the one or more processors to:
determine a stereotype associated with one or more users of a client device embodying an electronic program guide system;
select a channel having commercial collections associated with the at least one determined stereotype; and
present commercials from the commercial collection on the selected channel to one or more of the users.

99. The client device of claim 98, wherein the instructions cause the one or more processors to determine a stereotype group associated with the one or more users.

100. The client device of claim 98, wherein the instructions cause the one or more processors to determine a stereotype group associated with the one or more users, and select a channel associated with the stereotype group.

101. The client device of claim 98, wherein the instructions cause the one or more processors to present the commercials by recording the commercials from the commercial collection and presenting the commercials in accordance with one or more rules that govern the commercials' presentation.

102. The client device of claim 98, wherein the instructions cause the one or more processors to present the commercials in accordance with one or more rules that govern the commercials' presentation.

103. The client device of claim 98, wherein the instructions cause the one or more processors to ascertain which users are viewing programs on the client devices and present commercials that are appropriate for at least one of the users.

104. A method comprising:
associating stereotype attributes with individual commercials that are to be transmitted to multiple client devices, the stereotype attributes being configured to enable the client devices to select individual commercials whose stereotype attributes have a matching relationship with stereotype attributes of one or more users of the client device; and
transmitting the individual commercials over a network for receipt by multiple client devices.

105. The method of claim 104, wherein stereotype attributes that are selected from among a number of different demographic axes, the demographic axes being selected from a group comprising: gender, age, marital status, income, ethnic origin, religion, occupation.

106. One or more computer-readable media having computer-readable instructions thereon which, when executed by one or more processors, implements the method of claim 104.

107. One or more servers comprising:
one or more processors; and
one or more computer-readable media having computer-readable instructions thereon which, when executed by one or more processors, cause the one or more processors to:
associate stereotype attributes with individual commercials that are to be transmitted to multiple client devices, the stereotype attributes being configured to enable the client devices to select individual commercials whose stereotype attributes have a matching relationship with stereotype attributes of one or more users of the client device; and
transmit the individual commercials over a network for receipt by multiple client devices.

108. A method comprising:
receiving, with a client device, transmitted commercials;
determining whether stereotype attributes associated with any of the commercials match user attributes associated with the client device's users; and
presenting at least one commercial on the client device, the one commercial having at least one stereotype attribute that matches with a user of the client device.

109. The method of claim 108 further comprising for those commercials that have stereotype attributes that match with user attributes of the client device, calculating a relevancy score.

110. The method of claim 108 further comprising for those commercials that have stereotype attributes that match with user attributes of the client device, calculating a relevancy score, the act of presenting comprising presenting commercials having the highest relevancy scores.

111. The method of claim 108, wherein the act of presenting comprises ascertaining one or more users of the client device and presenting commercials that are appropriate for at least one of the users.

112. One or more computer-readable media having computer-readable instructions thereon which, when executed by one or more processors, implements the method of claim 108.

113. A client device comprising:
one or more processors; and
one or more computer-readable media having computer-readable instructions thereon which, when executed by one or more processors, cause the one or more processors to:
receive transmitted commercials;
determine whether stereotype attributes associated with any of the commercials match user attributes associated with the client device's users; and
present at least one commercial on the client device, the one commercial having at least one stereotype attribute that matches with a user of the client device.

114. The client device of claim 113, wherein the instructions cause the one or more processors to calculate a relevancy score for those commercials that have stereotype attributes that match with user attributes of the client device.

115. The client device of claim 113, wherein the instructions cause the one or more processors to calculate a relevancy score for those commercials that have stereotype attributes that match with user attributes of the client device, and present commercials having the highest relevancy scores.

116. The client device of claim 113, wherein the instructions cause the one or more processors to ascertain one or more users of the client device and present commercials that are appropriate for at least one of the users.

117. A method comprising:
ascertaining a user's viewing habits by evaluating a user's viewing log that contains information associated with programs that the user has viewed; and
presenting commercials to the user via a client device as a function of the user's viewing habits.

118. A method comprising:
ascertaining preference attributes from a user preference file associated with a user, the user preference file comprising part of an electronic program guide system; and
presenting commercials to the user as a function of the ascertained preference attributes.

119. A method comprising:
ascertaining a stereotype associated with a user of an electronic program guide system embodied on a client device; and
using the stereotype to configure a user interface associated with the electronic program guide system.

120. The method of claim 119, wherein the act of using comprises selecting an amount of information to display.

121. The method of claim 119, wherein the act of using comprises selecting a skin for the user interface.

122. The method of claim 119, wherein the act of using comprises selecting how the user interface is to appear.

123. A method comprising:
collecting user preference files associated with famous individuals; and
transmitting one or more of the user preference files to a client device, the user preference files defining preferences of famous individuals and being useable by an electronic program guide system to make program recommendations to users of the client device.

124. The method of claim 123 further comprising prior to transmitting the one or more user preference files to the client device, offering the one or more user preference files for sale.

125. A method comprising:
receiving, with a client device, one or more user preference files associated with famous individuals, the user preference files defining viewing preferences of famous individuals; and
using the one or more of the user preference files to make program recommendations to users of the client device.

126. The method of claim 125 further comprising prior to receiving the one or more user preference files, purchasing the one or more user preference files.
